(19) United States
(12) Patent Application Publication
(10) Pub. No.: US 2026/0229665 A1
(43) Pub. Date: Aug. 6, 2026

(54) BATTERY CLOSING BODY AND METHOD FOR PRODUCING SAME

(71) Applicant: NIPPON LIGHT METAL COMPANY, LTD., Tokyo (JP)

(72) Inventors: Masanori ENDO, Shizuoka (JP); Yusuke NISHIKORI, Shizuoka (JP); Hiroki IKEDA, Shizuoka (JP); Yoshihiko MORIYAMA, Shizuoka (JP); Takuma HACHISU, Kanagawa (JP); Donghai PIAO, Shanghai City (CN); Tatsuya CHIGUSA, Tokyo (JP); Masayoshi MABUCHI, Shizuoka (JP)

(21) Appl. No.: 19/150,430

(22) PCT Filed: Jan. 9, 2024
(86) PCT No.: PCT/JP2024/000212

§ 371 Date: Jul. 23, 2025

(30) Foreign Application Priority Data
Jan. 25, 2023 (JP) 2023-009651

(51) Int. Cl. H01M 50/188; H01M 50/159; H01M 50/193

(52) U.S. Cl. CPC H01M 50/188; H01M 50/159; H01M 50/193

(57) ABSTRACT

The present invention provides a battery closing body that improves the production efficiency and also can suppress the generation of hydrogen fluoride in the inside of a battery. A battery closing body is obtained by integrating a closing member that is formed from metal and closes an opening of a battery container, a terminal member formed from metal, and a gasket member that is interposed between the closing member and the terminal member, by a sealing member, wherein the gasket member contains a first thermoplastic resin that has resistance to hydrogen fluoride; the sealing member contains a second thermoplastic resin; the closing member has a generally planar main body part and a hole part that is provided so as to penetrate the main body part in a thickness direction; the gasket member that has been molded in advance is sandwiched between an outer peripheral portion of the terminal member and the inner peripheral portion of the hole part of the closing member; and the sealing member is injection-molded in a state in which the terminal member, the gasket member and the closing member are in close contact to the sealing member without existence of a space that forms an air layer between each of the members and the sealing member. A method for producing the battery closing body is also provided.

### TECHNICAL FIELD

The present invention relates to a battery closing body and a method for producing the same.

### BACKGROUND ART

A secondary battery is used that has a bottomed rectangular tubular shape or a bottomed cylindrical shape having an opening on one surface. A closing body is attached as a lid for sealing the opening of a case body of the secondary battery. In the closing body, a through hole is formed, and an electrode terminal is provided that is arranged so as to be inserted through the through hole. The electrode terminal is connected to a lead drawn from the inside of the battery, and can electrically connect the inside and the outside of the battery. Such a closing body and an electrode terminal are usually attached to the opening of the battery case body with satisfactory sealing properties.

For example, Patent Literature 1 discloses a battery case lid in which a lid plate having a lid through-hole and an electrode are covered with a holder resin. This Patent Literature 1 considers a conventionally adopted joining method by caulking as a problem, and describes a method of forming a fine groove in the lid plate and the electrode by laser treatment, then injection molding the lid plate and the electrode with a resin in an insert molding machine, and thereby, integrally molding the lid plate and the electrode with the holder resin.

In addition, Patent Literature 2 discloses an upper lid assembly of a secondary battery in which an electrode terminal is connected to a lid plate having an electrode lead-out hole via a seal ring (gasket). This Patent Literature 2 also describes that the electrode terminal is connected to the lid plate by a fixing member including a metal holder which is connected to the lid plate by welding, and an insulator covering the metal holder.

### CITATION LIST

### Patent Literature

Patent Literature 1: JP2020-145173 A
Patent Literature 2: JP2021-526707 A

### SUMMARY OF INVENTION

### Technical Problem

In Patent Literature 1, the electrode is covered with the holder resin, and thereby airtightness is provided between the holder resin and the battery lid. However, the holder resin is directly exposed to the inside of the battery, and accordingly there has been a case in which a resin constituting the holder resin or a filler contained in the holder resin is deteriorated by an action of hydrogen fluoride generated in the inside of the battery. Because of this, in the configuration as in the Patent Literature 1, it is necessary to select the holder resin and the filler which have resistance to hydrogen fluoride. In this respect, the resin material nylon exemplified in Patent Literature 1 cannot be said to be sufficient.

In addition, in Patent Literature 2, safety is improved by providing a seal ring working as a gasket between the electrode terminal and the lid plate. Here, in the closing body that is disclosed in Patent Literature 2, usually, firstly, a fixing member is formed that is a molded product which is formed by integrating a metal holder by injection molding an insulator covering the metal holder with a sealing member formed from a thermoplastic resin, against the metal holder. Next, the closing body is produced by setting the gasket (seal ring) so as to be such a positional relation as to be sandwiched between the electrode terminal and the lid plate, press-fitting the fixing member into the lid plate so as to cover the fixing member from the upper side of these members, and then welding the metal holder portion of the fixing member and the lid plate to each other. In such a production method, a process of forming the above fixing member and a welding process of welding a metal holder portion of the fixing member and the lid plate are required, and accordingly, there is a problem that the number of processes increases and the production efficiency decreases. In addition, in such a production method, the fixing member which is a molded product molded in advance by the sealing member is attached to the lid plate, and accordingly, there has been a case in which an air layer exists between the molded product including the electrode terminal and the sealing member and the gasket, and between the molded product including the electrode terminal and the sealing member and the lid body. In this case, there has been a problem that moisture in the air remaining in the air layer intrudes the inside of the battery, and is mixed into an electrolytic solution, and thereby hydrogen fluoride is generated in the inside of the battery. Because of this, similarly to the above Patent Literature 1, it is also necessary to select a resin material and a filler which have resistance to hydrogen fluoride.

In the present invention, an object is to provide a battery closing body that improves production efficiency and also can suppress the generation of hydrogen fluoride in the inside of the battery.

### Solution to Problem

Specifically, the gist of the present invention is as follows.
(1) A battery closing body that is obtained by integrating a closing member formed from metal that closes an opening of a battery container, a terminal member formed from metal, and a gasket member that is interposed between the closing member and the terminal member, by a sealing member, wherein
the gasket member contains a first thermoplastic resin which has resistance to hydrogen fluoride;
the sealing member contains a second thermoplastic resin; the closing member has a generally planar main body part and a hole part which is provided so as to penetrate the main body part in a thickness direction;
the gasket member that has been molded in advance is sandwiched between an outer peripheral portion of the terminal member and the inner peripheral portion of the hole part of the closing member; and
the sealing member is injection-molded in a state in which the terminal member, the gasket member and the closing member are in close contact to the sealing member without existence of a space that forms an air layer between each of the members and the sealing member.
(2) The battery closing body according to (1), wherein
the terminal member is arranged in a state in which at least a part of the terminal member is exposed on one main surface side of the closing member, and
the sealing member covers the outer peripheral portion of the terminal member, the gasket member, and the inner peripheral portion of the closing member, on the one main surface side.
(3) The battery closing body according to (1) or (2), wherein a lower end surface of the outer peripheral portion of the terminal member and an upper end surface of the inner peripheral portion of the hole part of the closing member area arranged so as to face each other while sandwiching the gasket member therebetween.
(4) The battery closing body according to (1) or (2), wherein an outer peripheral end surface of the outer peripheral portion of the terminal member and an inner peripheral end surface of the hole part of the closing member are arranged so as to face each other while sandwiching the gasket member therebetween.
(5) The battery closing body according to (3), wherein
the terminal member has a flange portion in the outer peripheral portion that, the flange portion having a surface opposite to a surface facing the closing member that is lowered by one step and protrudes and expands in an outer peripheral direction, and
the sealing member is molded so as to cover the whole surface of the flange portion which is exposed on the one main surface side, except for a portion of the flange portion in contact with the gasket member.
(6) The battery closing body according to (2), wherein
the terminal member has one or more flange portions in the outer peripheral portion, each of the flange portions having a surface on the one main surface side that is lowered by at least one step, protrudes and expands in an outer peripheral direction, and
at least one of the flange portions is arranged so that a step bottom surface of the flange portion and a lower end surface of an inner peripheral portion of the hole part of the closing member face each other while sandwiching the gasket member therebetween.
(7) The battery closing body according to (2), wherein the closing member has a stepped portion that is lowered by one step, in the inner peripheral portion on the one main surface side.
(8) The battery closing body according to (1) or (2), wherein
the closing member has a protruding portion that protrudes in a thickness direction in the vicinity of the inner peripheral portion,
the gasket member has a concave portion which is recessed in the thickness direction, and
the gasket member is sandwiched in a state in which the protruding portion of the closing member and the concave portion of the gasket member are fitted to each other so as to be in close contact with each other.
(9) The battery closing body according to (1) or (2), wherein
the terminal member has a circumferential concave portion in the outer peripheral portion, which is recessed inward in a circumferential direction; and
the gasket member has a concave portion that is recessed inward in a circumferential direction, and
the gasket member is sandwiched in a state in which an inner peripheral end portion of the closing member and the concave portion of the gasket member are fitted to each other so as to be in close contact with each other, and the gasket member and the concave portion of the terminal member are fitted to each other so as to be in close contact with each other.
(10) The battery closing body according to (1) or (2), wherein the closing member and the terminal member each have a bonding surface on which a hydroxyl group-containing film containing a hydroxyl group is formed, on an interface with the sealing member.
(11) The battery closing body according to (10), wherein
the hydroxyl group-containing film has a macro concave-convex portion including a plurality of concave-convex portions each having an opening diameter (D) of 20 μm to 200 μm, depths (L) of 20 μm to 200 μm, and aspect ratios (L/D) of the opening diameters (D) to the depths (L) of 0.5 to 5, and has fine concave-convex portions having a plurality of openings from 10 nm to 50 nm and a thickness of 10 nm to 1000 nm on the surface of the macro concave-convex portion, and
the closing member and the terminal member are each bonded to the sealing member via the bonding surface in a state in which the sealing member enters the macro concave-convex portions and the fine concave-convex portions.
(12) A method for producing a battery closing body that is obtained by integrating a closing member formed from metal that closes an opening of a battery container, a terminal member formed from metal, and a gasket member that is interposed between the closing member and the terminal member, by a sealing member, wherein
the gasket member contains a first thermoplastic resin which has resistance to hydrogen fluoride;
the sealing member contains a second thermoplastic resin;
the closing member has a generally planar main body part and a hole part which is provided so as to penetrate the main body part in a thickness direction, wherein
the method comprises: a member preparation step of sandwiching the gasket member molded in advance between an outer peripheral portion of the terminal member and an inner peripheral portion of the hole part of the closing member; and
an injection molding step of injection-molding the sealing member so that the sealing member reaches a state of being in close contact with the terminal member, the gasket member, and the closing member without existence of a space that forms an air layer between each of the members and the sealing member.
(13) The method for producing a battery closing body according to (12), wherein
in the member preparation step, the terminal member is arranged in a state in which at least a part of the terminal member is exposed on one main surface side of the closing member; and
in the injection molding step, the injection molding is performed so that the sealing member covers the outer peripheral portion of the terminal member, the gasket member, and the inner peripheral portion of the closing member, on the one main surface side.
(14) The method for producing a battery closing body according to (12) or (13), comprising a film forming step of forming a bonding surface on which a hydroxyl group-containing film containing a hydroxyl group is formed, on each of surfaces of the closing member and the terminal member, by laser treatment of irradiating the surfaces of the closing member and the terminal member with laser light, wherein
the member preparation step and the injection molding step are performed with the use of the closing member and the terminal member obtained in the film forming step.
(15) The method for producing a battery closing body according to (14), wherein
in the film forming step, the bonding surface is formed on each of the outer peripheral portion of the terminal member and the inner peripheral portion of the hole part of the closing member, on the one main surface side on which the injection molding is performed;
in the member preparation step, the terminal member and the closing member are arranged so that the bonding surface formed on the terminal member and the bonding surface formed on the closing member are exposed toward the one main surface side; and
in the injection molding step, the injection molding is performed so that the sealing member covers the bonding surfaces of the terminal member and the closing member, on the one main surface side.

### Advantageous Effect of Invention

According to the present invention, it is possible to provide a battery closing body that improves the production efficiency and suppresses the generation of hydrogen fluoride in the inside of the battery.

### BRIEF DESCRIPTION OF DRAWINGS

FIG. 1 is a schematic view showing a shape of a top surface of a battery closing body of an embodiment 1 of the present invention.

FIG. 2 is a schematic view showing a shape of a lower surface of the battery closing body of the embodiment 1 of the present invention.

FIG. 3 is a cross-sectional view taken along the line A-A in FIG. 1, and is a schematic cross-sectional view of the battery closing body according to the embodiment 1 of the present invention.

FIG. 4 is a schematic cross-sectional view showing a positional relationship when a gasket member and a closing member are arranged in the embodiment 1 of the present invention.

FIG. 5 is a schematic view showing one example of a method of determining an opening diameter (D) and a depth (L) in a macro concave-convex portion.

FIG. 6 is a schematic view showing a relationship between a beam diameter of a laser beam and an irradiation interval.

FIG. 7 is a schematic cross-sectional view of a battery closing body according to an embodiment 2 of the present invention.

FIG. 8 is a schematic cross-sectional view showing a positional relationship when a gasket member and a closing member are arranged in the embodiment 2 of the present invention.

FIG. 9 is a schematic cross-sectional view of a battery closing body according to an embodiment 3 of the present invention.

FIG. 10 is a schematic cross-sectional view of a battery closing body according to an embodiment 4 of the present invention.

FIG. 11 is a schematic cross-sectional view showing a positional relationship when a gasket member and a closing member are arranged in the embodiment 4 of the present invention.

FIG. 12 is a schematic cross-sectional view of a battery closing body according to an embodiment 5 of the present invention.

FIG. 13 is a schematic cross-sectional view of a battery closing body according to an embodiment 6 of the present invention.

FIG. 14 is a schematic cross-sectional view showing a positional relationship when a terminal member, a gasket member, and a closing member are arranged in an embodiment 6 of the present invention.

### DESCRIPTION OF EMBODIMENTS

The battery closing body of the present invention will be described in detail below together with a method for producing the same. The present invention is not limited to the following embodiments, and various modifications and combinations are possible without departing from the gist of the present invention. In addition, in the present specification and the drawings, components having substantially the same functions are denoted by the same reference numerals, and redundant description thereof may be omitted.

In the battery closing body of the present embodiment, a closing member formed from metal for closing an opening of a battery container, a terminal member formed from metal, and a gasket member interposed between the closing member and the terminal member are integrated by a sealing member. Here, the gasket member contains a first thermoplastic resin having resistance to hydrogen fluoride, and the sealing member contains a second thermoplastic resin. The closing member includes a generally planar main body part, and a hole part provided so as to penetrate the main body part in a thickness direction. The gasket member that has been molded in advance is sandwiched between the outer peripheral portion of the terminal member and the inner peripheral portion of the hole part of the closing member; and the sealing member is injection-molded in a state in which the terminal member, the gasket member and the closing member are in close contact to the sealing member without existence of a space that forms an air layer between each of the members and the sealing member.

In addition, in the battery closing body of the present embodiment, it is preferable that the terminal member is arranged in a state in which at least a part of the terminal member is exposed on one main surface side of the closing member, and the sealing member covers the outer peripheral portion of the terminal member, the gasket member, and the inner peripheral portion of the closing member, on the one main surface side. Because the sealing member is provided on the one main surface side of the closing member, when an electrolytic solution exists on the other surface side (battery inner side), the sealing member is separated by the terminal member, the gasket member, and the closing member, and such a possibility can be avoided that the sealing member is exposed to the electrolytic solution. In addition, because the injection molding is performed from the one main surface side of the closing member on the one main surface side of the closing member in a state in which the terminal member is arranged while sandwiching the gasket member, the production (assembly and injection molding) is facilitated, which is preferable.

The battery closing body of the present invention will be specifically described below, based on preferable embodiments 1 to 6.

### 1. Embodiment 1

### [1-1. Battery Closing Body]

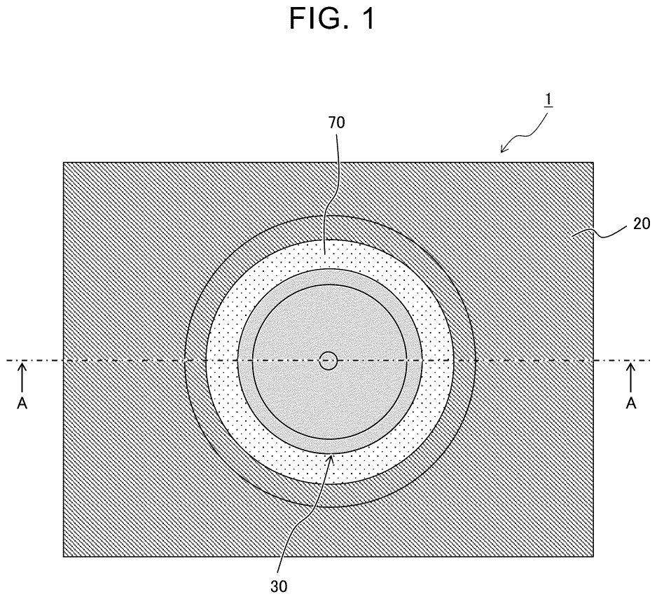

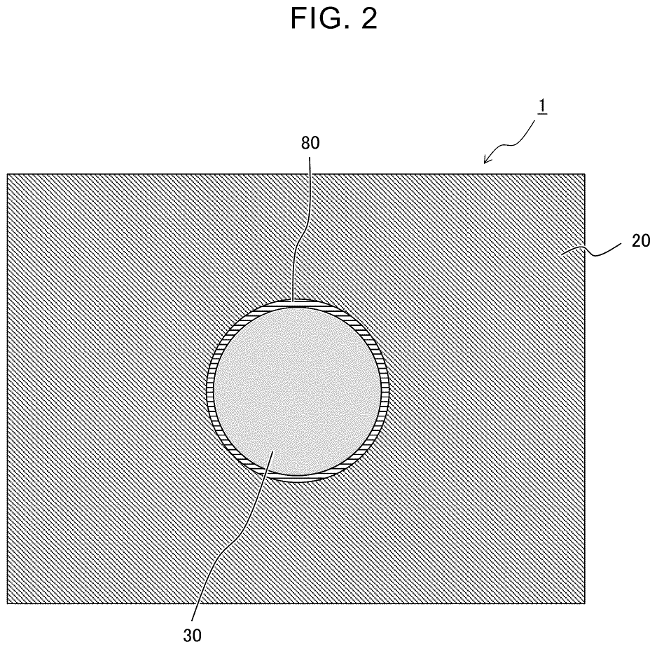

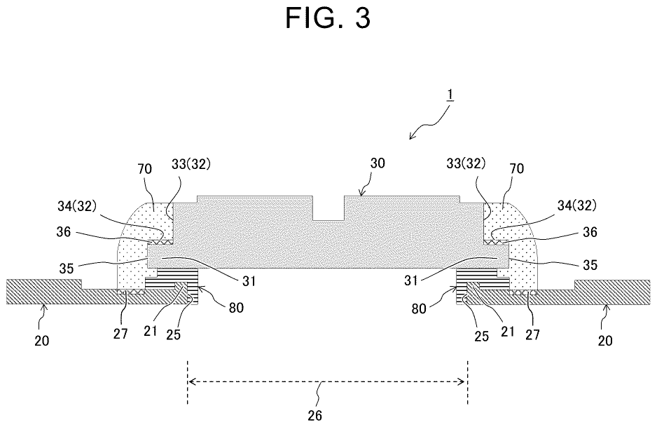

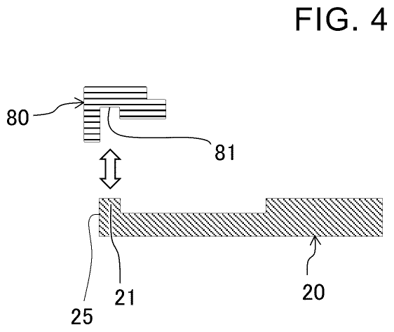

FIGS. 1 to 4 show a battery closing body 1 according to an embodiment 1 of the present invention, FIG. 1 is a top view, FIG. 2 is a bottom view, and FIG. 3 is a cross-sectional view taken along the line A-A in FIG. 1. FIG. 4 is a cross-sectional view showing a part of a state in which the gasket member 80 and the closing member 20 are arranged on the way of production of the battery closing body 1. The battery closing body 1 shown in these figures is used for either of a positive electrode or a negative electrode, and shows a part of the closing body in each electrode, and a size of each constituent member can be appropriately changed according to a size, a shape and the like of an opening of a battery to be used. The same applies to the following embodiments 2 to 6.

Referring to FIGS. 1 to 4, the battery closing body 1 according to the embodiment 1 includes the closing member 20, a terminal member 30, the gasket member 80, and a sealing member 70. As can be seen from FIG. 3, the gasket member 80 is interposed (sandwiched) between an outer peripheral portion of the terminal member 30 and an inner peripheral portion of the closing member 20. Here, the above “outer peripheral portion” and the “inner peripheral portion” are not limited to the end portion of the outer periphery (or inner periphery) and a side surface of the end portion, and may widely include the peripheral portion thereof. In other words, the “outer peripheral portion” and the “inner peripheral portion” may be a wide region including the end portion or the side surface of the end portion, or may be a region slightly inside the outer peripheral portion or a region slightly outside the inner peripheral portion, without including the end portion.

The closing member 20, the terminal member 30, and the gasket member 80 are integrated by the sealing member 70. The sealing member 70 is injection-molded in a state in which the sealing member 70 is in close contact with the terminal member 30, the gasket member 80 and the closing member 20, without existence of a space that forms an air layer between each of the members and the sealing member. In addition, it is desirable that the sealing member 70 is bonded to each of the terminal member 30, the gasket member 80 and the closing member 20.

The expression “space that forms an air layer” refers to a space in which air, water vapor or a gas other than air can be retained, but the present invention is configured such that this space does not exist. When moisture exists in the air layer, hydrogen fluoride may be generated from an electrolyte (for example, fluorine-containing compound such as LiPF₆) in the electrolytic solution caused by the moisture, and accordingly, the generation of hydrogen fluoride can be prevented by preventing the air layer from existing. For information, it can be determined that the space due to the air layer does not exist, for example, by observing a cut surface of a corresponding portion at which the sealing member 70 has been injection-molded, at a magnification of 50,000 times with the use of an electron microscope such as an SEM, and thereby confirming that no void exists in the measurement field of view.

The resin material forming the sealing member 70 receives high temperature and high pressure at the time of being injection-molded, and thereby, the molten or plasticized resin material results in coming into contact with the terminal member 30, the gasket member 80 and the closing member 20. At this time, the resin material flows into the inside of the fine concave-convex structure existing on the surface of each of the terminal member 30, the gasket member 80 and the closing member 20. Then, the resin material is solidified, and thereby, the sealing member 70 results in being formed in a state in which an anchor effect is exhibited with each of the terminal member 30, the gasket member 80, and the closing member 20. In addition, the resin material approaches each of the terminal member 30, the gasket member 80 and the closing member 20, to such an extent that the resin material can be bonded to each of the members by an action of an intermolecular force such as hydrogen bonding or the van der Waals force. Then, the resin material is solidified, and thereby, the sealing member 70 results in being formed in a state in which an intermolecular force is exhibited with each of the terminal member 30, the gasket member 80, and the closing member 20. In addition, the gasket member 80 which has come in contact with the injected resin material is melted, according to the conditions of the injection molding and the materials used for the sealing member 70 and the gasket member 80, and the resin material and the gasket member 80 are fused. Then, the resin material and the gasket member 80 are solidified, and thereby, the sealing member 70 results in being formed in a state of being integrated with the gasket member 80.

In this way, the sealing member 70 is bonded to each of the terminal member 30, the gasket member 80 and the closing member 20, through at least one action selected from the group consisting of an anchor effect, an intermolecular force, and fusion due to melting. Thereby, the sealing member 70 reaches a state of being in close contact with the terminal member 30, the gasket member 80 and the closing member 20, without existence of a space that forms an air layer between the sealing member 70 and each of the rest members, and thereby can prevent a leak path from being formed. From the viewpoint of blocking the occurrence of the leak path, it is preferable that at least one place (one piece) of continuous bonded portion is provided, in such a form as to cross the flow path between the inside and the outside of the battery passing through the hole part 26, at the interface between the sealing member 70 and each of the terminal member 30, the gasket member 80 and the closing member 20, and is more preferable that a plurality of places (a plurality of pieces) of continuous bonded portions are provided.

The closing member 20 is a member that seals an opening of a battery container (not shown), and as shown in FIGS. 1 to 4, is generally planar (referred to as main body part); and includes the main body part and a hole part 26 that is provided so as to penetrate the main body part in a thickness direction. The hole part 26 is configured to have substantially the same shape as the outer peripheral portion of the terminal member 30, in a plan view. For example, when the terminal member 30 is generally columnar and the outer peripheral portion of the terminal member 20 is circular in a plan view, the hole part 26 also is circular. The closing member 20 may have a protruding portion 21 that protrudes in the thickness direction, in the vicinity of the inner periphery of the hole part 26. In the present embodiment, the closing member 20 has the protruding portion 21 that protrudes toward one main surface side (battery outer side), in the vicinity of the inner periphery of the hole part 26. Due to having the protruding portion 21, the closing member 20 can enhance a state of installation and fitting with the gasket member 80.

The shape of the closing member 20 can be appropriately changed according to a shape of the battery opening, but is usually rectangular or circular and is a generally planar plate material (main body part); and the above hole part 26 is formed in the central portion. If necessary, the main body part may be appropriately processed or a member may be added thereto, and for example, the main body part may have a shape in which a leg portion to be inserted into the battery container extends downward (toward the other main surface side (battery inner side)) from the main body part.

The closing member 20 is formed from metal, and as the metal, there are a copper material formed from copper or a copper alloy, an iron material formed from iron or an iron alloy, an aluminum material formed from aluminum or an aluminum alloy, or the like; and the material is not limited, and can be determined based on various physical properties such as strength, corrosion resistance and workability which are required for closing of the battery. Usually, an oxide film is formed on the surface of these metal materials. The oxide film may be a natural oxide film which is formed naturally in the atmosphere, or may be an anodic oxide film which is formed by anodic oxidation. In addition, the oxide film may be a rolled oxide film which is formed by hot rolling.

The terminal member 30 is an electrode terminal which is connected to a lead drawn from the inside of the battery, and electrically connects the inside of the battery and the outside. The terminal member 30 is formed from metal, and metal materials similar to the above are used. As shown in FIGS. 1 to 3, the terminal member 30 has a columnar central portion and a first flange portion 31 which expands from the central portion, and has a generally columnar shape as a whole. The terminal member 30 may have other shapes (such as a generally prismatic shape and a generally planar shape), may also have an expanded portion such as the first flange portion 31, a shaved portion, or the like, and can be appropriately changed according to a battery to be used. The terminal member 30 is provided so as to overlap with the protruding portion 21 which protrudes toward the one main surface side in the vicinity of the inner periphery of the closing member 20 in a plan view, and is arranged so as to cover at least the hole part 26 in the embodiment 1.

The gasket member 80 is molded in advance. As a molding method, a known method such as press molding or injection molding can be used. The gasket member 80 is interposed between the closing member 20 and the terminal member 30. The gasket member 80 has an annular shape having a space in the inside. The gasket member 80 has an annular portion which has a shape corresponding to the outer peripheral portion of the terminal member 30. In a state in which the gasket member 80 is interposed between the closing member 20 and the terminal member 30, it is possible to reach the terminal member 30 from the other main surface side of the closing member 20, through an inner space portion surrounded by the annular portion of the gasket member 80. In addition, the gasket member 80 is configured to be a shape corresponding to the inner peripheral portion of the hole part 26 of the closing member 20. In a state in which the gasket member 80 is interposed between the closing member 20 and the terminal member 30, an inner space portion surrounded by the annular portion of the gasket member 80 is configured to be in a relationship of substantially matching the hole part 26. For example, in a case where the terminal member 30 is generally columnar, the outer peripheral portion of the terminal member 30 is circular, and the hole part 26 is circular in a plan view, the gasket member 80 also has an annular shape in the plan view. The gasket member 80 has a function of closing a gap between the closing member 20 and the terminal member 30, and enhancing airtightness and watertightness. The gasket member 80 can suppress the influence of hydrogen fluoride generated from the electrolytic solution inside the battery, on the sealing member 70 and the filler contained in the sealing member 70.

For that purpose, the gasket member 80 contains a thermoplastic resin (first thermoplastic resin) having resistance to hydrogen fluoride. Examples of the first thermoplastic resin include: fluororesins such as polytetrafluoroethylene (PTFE), perfluoroalkoxy alkane (PFA), a perfluoroethylene propane copolymer (FEP), an ethylene tetrafluoroethylene copolymer (ETFE), and polyvinylidene fluoride (PVDF); polyolefin resins such as polyethylene (PE) and polypropylene (PP); and polyphenylene sulfide (PPS), but the resins are not limited thereto. As the first thermoplastic resin, a fluororesin such as PTFE or PFA is preferable, from the viewpoint of the resistance to hydrogen fluoride.

The shape of the gasket member 80 is not limited to the illustrated shape, and can be changed as appropriate, according to the shapes of the portions of the terminal member 30 and the closing member 20 that are in contact with the gasket member 80, the degrees of the close contacts, and the like.

The sealing member 70 is a member that covers and seals the terminal member 30, the gasket member 80 and the closing member 20, from one main surface side (battery outer side) by injection molding, and integrates these members. The shape of the sealing member 70 can be appropriately changed according to the shape of another member to be integrated, as long as the object of the present invention is not impaired.

The sealing member 70 is configured to include a thermoplastic resin (second thermoplastic resin). The second thermoplastic resin may be the same as or different from the first thermoplastic resin, and is not limited, but is preferably a resin that easily enters the contact surface with each of the above members by being injection-molded. The second thermoplastic resin does not necessarily have the resistance to hydrogen fluoride, but may have the resistance to hydrogen fluoride. Examples of preferable second thermoplastic resins include: fluororesins such as PTFE, PFA, FEP, ETFE and PVDF; polyolefin resins such as PE and PP; and PPS and polyether ether ketone (PEEK). In order to prevent the gasket member 80 from being deformed at the time of injection molding, it is preferable to select a second thermoplastic resin having a heat-resistant temperature lower than that of the first thermoplastic resin. As the second thermoplastic resin, PP or PPS is preferable from the viewpoint of injection moldability and the resistance to hydrogen fluoride; and PPS is more preferable from the viewpoint of the injection moldability, the resistance to hydrogen fluoride, and voltage resistance.

In the present invention, even when the injection conditions are different between the gasket member 80 and the sealing member 70, both can be integrally molded in combination, by inserting the gasket member 80 molded in advance, and then, injection molding the sealing member 70.

In addition, it is preferable to blend various fillers in the sealing member 70 for the purpose of improving mechanical strength, suppressing a volume change, and the like. As the filler, any known inorganic filler or the like can be used, but in particular, it is preferable that a glass filler (usually, about 30 to 70% by mass) is blended as the filler, for the purpose of withstand voltage and dimensional stability for the use of the present invention. When the glass filler is blended, it becomes particularly important that the sealing member 70 is arranged in a state of coming in close contact with each member so that the space to be an air layer does not exist, in order to prevent hydrogen fluoride from being generated from the electrolytic solution as in the above, because glass is attacked by hydrogen fluoride.

As for a specific configuration of the embodiment 1, as shown in FIG. 3, the closing member 20 has the circular hole part 26 that penetrates the generally planar main body part. The closing member 20 has the protruding portion 21 which protrudes toward one main surface side in the vicinity of the inner peripheral portion of the hole part 26. In addition, the gasket member 80 has an annular shape in plan view; and has an inner peripheral portion that forms a concave portion having an inner wall surface which comes in contact with an inner peripheral side surface of the protruding portion 21, a tip end surface of the protruding portion 21 which faces the terminal member 30, and an outer peripheral side surface of the protruding portion 21; and an outer peripheral portion that expands from the inner peripheral portion in an outer peripheral direction, and comes in contact with an upper surface of a flat surface portion of the closing member on the one main surface side. In this way, the closing member 20 has the protruding portion 21 that protrudes in the thickness direction in the vicinity of the inner peripheral portion; and the gasket member 80 has the concave portion 81 which is recessed in the thickness direction. Then, as shown in FIG. 4, the gasket member 80 is sandwiched in a state in which the protruding portion 21 of the closing member 20 and the concave portion 81 of the gasket member 80 are fitted to each other so as to be in close contact with each other. Thereby, the positioning of the gasket member 80 to the closing member 20 is facilitated at the time of assembly. In addition, it becomes easy to prevent the gasket member 80 from moving at the time of injection molding.

Furthermore, the inner peripheral portion of the gasket member 80 in which the protruding portion 21 and the concave portion 81 are fitted to each other is sandwiched from above and below between the lower surface (lower end surface; battery inner side) of the outer peripheral portion of the terminal member 30 and the upper surface (upper end surface; battery outer side) of the inner peripheral portion of the hole part 26 of the closing member 20, which face each other. In the embodiment 1, the terminal member 30 is arranged so as not to enter the hole part 26 of the closing member 20. In other words, the outer peripheral portion of the terminal member 30, the gasket member 80, and the inner peripheral portion of the hole part 26 of the closing member 20 are arranged in a state of being stacked in this order from the top (battery outer side). Due to these members being arranged in this stacking order, these members are configured to be covered by the sealing member 70 on one main surface side (battery outer side). As a result, as in the above, the sealing member 70 is separated from the other main surface side (battery inner side) of the closing member 20 by the terminal member 30, the gasket member 80 and the closing member 20, and it becomes possible to avoid the possibility that the sealing member 70 is exposed to the electrolytic solution. In addition, the sealing member 70 is formed by the injection molding from the one main surface side, and the production (assembly and injection molding) is facilitated, which is preferable.

In addition, as shown in FIG. 3, the terminal member 30 has the first flange portion 31 in its outer peripheral portion, in which the surface opposite to the surface facing the closing member 20 is lowered by one step, and protrudes and expands in an outer peripheral direction from the central portion. In other words, the terminal member 30 has the first flange portion 31 in its outer peripheral portion, in which the surface on the one main surface side is lowered by one step, and protrudes and expands in an outer peripheral direction from the central portion. Due to having the first flange portion 31, a first step portion 32 is formed that is formed of a first step side surface 33 (32) which is a side surface of the central portion, and a first step bottom surface 34 (32) which is an upper surface of the first flange portion 31. Due to having such a first step portion 32 and a first flange portion 31, the terminal member 30 can be arranged in a state of being stacked on the gasket member 80 and the closing member 20, as in the above. In addition, due to the first step portion 32 and the first flange portion 31 being provided, the sealing member 70 is brought into close contact with the first step side surface 33 (32), the first step bottom surface 34 (32), an outer peripheral end surface (outer peripheral side surface) 35 of the first flange portion 31, the lower surface of the first flange portion 31, the gasket member 80, and the main body part of the closing member 20. In other words, the sealing member 70 is injection-molded so as to cover the whole surface which is exposed to the one main surface side except for the portion in contact with the gasket member 80 in the outer peripheral portion of the terminal member 30; and accordingly, the airtightness and the watertightness are enhanced, and also, an adhesive strength is enhanced. The widths (lengths) of each of the side surfaces and the bottom surfaces of the first step portion 32 and the first flange portion 31 (the first step side surface 33 (32), the first step bottom surface 34 (32), and the outer peripheral end surface (outer peripheral side surface) 35 of the first flange portion 31) can be appropriately changed according to the purpose, in consideration of the shape of the terminal member 30, the degree of the close contact (bonding) with the sealing member 70, and the like. The same applies to the following embodiments.

### [1-2. Hydroxyl Group-Containing Film]

It is preferable that a hydroxyl group-containing film containing a hydroxyl group is formed at interfaces between each member of the closing member 20 and the terminal member 30 and the sealing member 70 that comes in close contact (bonded) therewith, (where these interfaces are referred to as bonding surface 27 and a bonding surface 36, respectively). The hydroxyl group-containing film macroscopically has a “macro concave-convex portion” in which concave portions and convex portions are alternately and continuously formed, and a “fine concave-convex portion” which is formed on the surface of the macro concave-convex portion. When the closing member 20 and the terminal member 30 has the bonding surface 27 and the bonding surface 36, respectively, the sealing member 70 is brought into close contact with (bonded to) the closing member 20 and the terminal member 30 via the respective bonding surfaces in a state of entering the macro concave-convex portion and the fine concave-convex portion, and accordingly a sufficient bonding strength and airtightness can be expected to be exhibited. In addition, it is preferable that the bonding surface 27 and the bonding surface 36 are each formed on the surfaces of the one main surface side on which the injection molding is performed for the closing member 20 and the terminal member 30, as shown in FIG. 3. In the present embodiment, the bonding surface 36 is formed on the upper side (first step bottom surface 34 (32)) of the first flange portion 31 of the terminal member 30. In addition, the bonding surface 27 is formed in a portion in the vicinity of the inner peripheral side surface 25 of the hole part 26 of the closing member 20, and in the outer peripheral direction relative to the position of the gasket member 80. Because the terminal member 30 is arranged so as to be exposed on one main surface side, and the bonding surface 27 and the bonding surface 36 that have the hydroxyl group-containing film are formed on the one main surface side covered with the sealing member 70, a sufficient bonding strength and airtightness can be expected to be exhibited.

Such a hydroxyl group-containing film contains, for example: a hydroxide of a metal (metal hydroxide) constituting a metal base material, such as aluminum hydroxide (Al(OH)₃), aluminum oxide hydroxide (AlO(OH)), copper hydroxide (Cu(OH)₂), iron (II) hydroxide (Fe(OH)₂), and iron (III) oxide hydroxide (FeO(OH)); or an oxide hydroxide of a metal (metal oxide hydroxide) constituting each member, according to each metal constituting the terminal member 30 or the closing member 20. In addition, the hydroxyl group-containing film may contain, for example, oxides of metals (metal oxides) constituting each of the members, such as aluminum oxide (Al₂O₃), copper (I) oxide (Cu₂O), copper (II) oxide (CuO), iron (II) oxide (FeO), iron (II, III) oxide (Fe₃O₄), and iron (III) oxide (Fe₂O₃), according to the metals constituting each of the members.

The hydroxyl group-containing film can be confirmed by detection of hydroxyl groups existing near the surface layer of each of the bonding surfaces of the terminal member 30 and the closing member 20, with glow discharge optical emission spectrometry (GD-OES), for example. Specifically, firstly, the emission intensities (V) derived from the main metal and the hydroxyl group, which constitutes each member, are measured in a thickness direction at each bonding surface, with the use of GD-OES. Subsequently, a detected amount of the main metal which constitutes each member is calculated from an integrated value (area) of the emission intensity derived from the main metal. In addition, a detected amount of the hydroxyl group is measured from the integrated value of the emission intensity derived from the hydroxyl group. Furthermore, a ratio of the detected amount of the hydroxyl group to the total amount of the detected amount of the main metal and the detected amount of the hydroxyl group is calculated as an abundance ratio of the hydroxyl group. In the emission spectrum obtained by GD-OES, the peaks appearing in 281 nm and 309 nm shall be regarded as peaks derived from hydroxyl groups. The emission intensity near the surface layer of each of the members by GD-OES may be measured in a region from the surface to the depth of 200 nm. To be specific, the emission intensity is measured in a range after the detection of the emission intensity derived from the elements of the main metals constituting each member and the hydroxyl group, until the time elapses which is required for sputtering of the 200 nm portion corresponding to the elements of the main metals. The range (time) of this measurement can be grasped by measuring a sputtering rate (μm/min) of a standard sample in advance, which contains the main metal element to be measured with high purity. Due to the measurement of the emission intensity with the use of GD-OES, it becomes possible to detect and evaluate not only the components existing in the outermost layer of each member, but also the components existing in a region down to a certain depth, which can contribute to bonding with the resin of the sealing member 70.

It is preferable for the abundance ratio of the hydroxyl group to be 4% or larger, is more preferable to be 5% or larger, is further preferable to be 6% or larger, and is particularly preferable to be 7% or larger. When the abundance ratio of the hydroxyl group is the above lower limit value or larger, the hydroxyl group increases which exists in the vicinity of the surface of each bonding surface of each member, and can be expected to interact with the functional group contained in the resin of the sealing member 70. In addition, at this time, the bonding strength and airtightness of the sealing member 70 also tend to be improved. The upper limit of the abundance ratio of the hydroxyl group is not particularly limited, but it is preferable to be 70% or smaller, is more preferable to be 50% or smaller, is further preferable to be 40% or smaller, and is particularly preferable to be 30% or smaller. The abundance ratio of the hydroxyl group varies depending on a method of forming the hydroxyl group. For example, the abundance ratio of the hydroxyl group tends to be higher in the case where each member has been subjected to wet treatment of: hydrated oxide treatment with warm water or hot water; chemical conversion treatment; and zincate treatment, than the case where the above each member has been subjected to laser treatment. When the hydroxyl group-containing film is formed by the laser treatment, a content of the hydroxyl group is preferably 30% or less, more preferably 20% or less, or further preferably 15% less, and particularly preferably 10% or less.

On the surface of each bonding surface of the above each member, a deposit is formed in a film shape, which is a metal oxide formed due to laser irradiation, which has deposited around an irradiated portion. A molten metal layer formed of such a deposit contains oxygen as the metal oxide as in the above. The molten metal layer has a hydroxyl group-containing film having a hydroxyl group on the outermost layer. In the present invention, as in the above, it is preferable that the whole surface of each of the bonding surfaces is covered with the hydroxyl group-containing film having the macro concave-convex portion and the fine concave-convex portion. The “whole surface of the bonding surface” is not necessarily limited to 100% of the surface area of each bonding surface of the bonding surface 27 or the bonding surface 36, and does not exclude a case where a surface that is not covered with the hydroxyl group-containing film due to an unirradiated portion exists in the form of a very small spot. Each of the bonding surfaces is preferably covered with the hydroxyl group-containing film by 90% or more, and more preferably 95% or more.

### <Macro Concave-Convex Portion>

The macro concave-convex portion is a structure having a concave-convex shape of a μm order size, and is formed on the surface of the hydroxyl group-containing film. The macro concave-convex portion has a structure including a concave portion formed by perforation of the metal base material due to receiving the irradiation of the laser light, and a convex portion formed of a deposit of a metal oxide which has been formed by the irradiation with the laser light. In addition, the laser light is emitted a plurality of times so as to be adjacent to each other, and thereby, the macro concave-convex portion has a structure in which a concave portion and a convex portion are repeated. The macro concave-convex portion can be confirmed by observation of the surface or the cross section of the bonding surface with the use of a scanning electron microscope (SEM), for example.

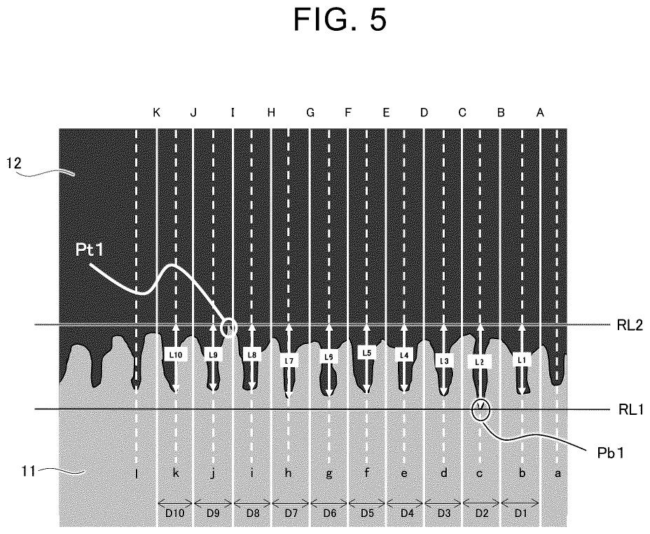

It is preferable that the macro concave-convex portion has a predetermined opening diameter (D) and a predetermined depth (L) which are obtained from a procedure that will be described with reference to FIG. 5. The macro concave-convex portion contains a metal hydroxide or a metal oxide hydroxide, similarly to the hydroxyl group-containing film. In addition, the macro concave-convex portion may contain a metal oxide similarly to the hydroxyl group-containing film.

Here, in order to calculate the opening diameter (D) and the depth (L), each member of the terminal member 30 or the closing member 20 is observed with the use of SEM, or a bonded cross section in a state in which the sealing member 70 is brought into close contact with (bonded to) each member is observed, and a cross-sectional photograph is taken that includes a plurality of concave-convex portions formed by laser irradiation, in which at least 12 concave portions and 11 convex portions are alternately and continuously arranged. Then, the opening diameter (D) and the depth (L) can be calculated from the plurality of concave-convex portions included in the cross-sectional photograph.

Specifically, as shown in FIG. 5, the opening diameter (D) and the depth (L) are determined by providing the following lines after the cross-sectional photograph has been acquired. FIG. 5 is an example of a view schematically illustrating a cross section that can be used for calculating the opening diameter (D) and the depth (L) of the macro concave-convex portion. This FIG. 5 assumes a case where the resin molded body 12 corresponding to the sealing member 70 is bonded to a metal member 11 corresponding to any of the members of the terminal member 30 or the closing member 20, in which the macro concave-convex portion is formed.

Firstly, in FIG. 5, with respect to 12 continuous concave portions that have been arbitrarily selected, the deepest portion among the lowest portions that are the deepest positions of the respective concave portions is defined as the lowest concave portion Pb1. A reference line RL1 is drawn which passes through the lowest concave portion Pb1, or passes through a position lower than Pb1 and also passes through a position at which the sum of distances from the respective positions of the lowest portions of the concave portions is the smallest. Next, the highest convex portion among the convex portions sandwiched between the above-described 12 concave portions is defined as the highest convex portion Pt1. A reference line RL2 is drawn which passes through the highest convex portion Pt1 and also is parallel to the reference line RL1. In this way, due to the RL1 and the RL2 being drawn so as to pass through the lowest concave portion Pb1 and the highest convex portion Pt1, respectively, when the depth L is calculated, it becomes possible to prevent the aspect ratios (L/D) from resulting in being calculated to be large or small, as a result of being calculated to be excessively larger or smaller than the original value. Subsequently, with respect to the 12 continuous concave portions including the lowest concave portion Pb1, 12 straight lines are drawn from the lowest portion of each concave portion in a direction perpendicular to the reference line RL2, and these straight lines are sequentially designated as a line a to a line 1 (indicated by broken lines in FIG. 5).

With respect to the above-described line a to line 1, parallel midlines are drawn in the middle of the lines adjacent to each other, and these midlines are referred to as lines A to K in the respective order. A space between the line A and the line B is obtained as an opening diameter D1 of the concave portion that is sandwiched between the line A and the line B and also through which the line b passes. Similarly, the spaces between adjacent lines of the A to K lines are obtained as the opening diameters D1 to D10. In addition, in each of the line b to the line k, the distances from the lowest portion of each concave portion to the reference line RL2 are obtained as the depths L1 to L10 of the ten concave portions. The opening diameters D1 to D10 and the depths L1 to L10 correspond to the opening diameters D and the depths L of the ten concave portions, respectively, through which the line b to the line k pass, which exclude the line a and the line 1 at both ends, among the line a to the line 1, respectively.

In this way, the depths L1 to 10 and the opening diameters D1 to D10 can be obtained for the ten concave portions through which the line b to the line k included in FIG. 5 pass, respectively. Furthermore, outliers are detected from the depths L1 to 10 and the opening diameters D1 to D10, with the use of the Smirnov-Grubbs test. In order to detect the outliers, firstly, for the ten concave portions at the depths L1 to L10, the test statistic t is calculated by calculating absolute deviation by subtracting the average value of the depths L1 to L10 from the value of each depth L, and dividing the calculated absolute deviation by an unbiased standard deviation of the depths L1 to L10. Next, a p-value is determined which represents the probability that the test statistic t becomes the value. Then, such a value that the p-value is smaller than 5% is detected as the outlier. When the outlier has been detected, the depth L of the concave portion at which the outlier has been detected is excluded from the ten concave portions at the depths L1 to L10, and the outlier is detected again for the depths L of the remaining concave portions, and the operation is repeated until the outlier is not detected. Similarly, outliers are detected from the opening diameters D1 to D10. Furthermore, for the ten concave portions through which the line b to the line k included in FIG. 5 pass, respectively, the average value of the depths L and the average value of the opening diameters D are calculated from the depths L and the opening diameters D of the remaining concave portions excluding the concave portions in which the outlier has been detected in one or both of the depth L and the opening diameter D. The average value of the depth L and the average value of the opening diameter D obtained in this way are defined as the depth (L) and the opening diameter (D) of the macro concave-convex portion.

Furthermore, with respect to the ten concave portions through which the line b to the line k included in FIG. 5 pass, respectively, an aspect ratio (L/D) is calculated by dividing the depth L of each concave portion by the opening diameter D of each concave portion, from the depths L and the opening diameters D of the remaining concave portions excluding the concave portions in which the outlier has been detected in one or both of the depth L and the opening diameter D. Then, an average value of the aspect ratios (L/D) of the plurality of concave portions is calculated from the aspect ratio (L/D) of each concave portion. The average value of the aspect ratios (L/D) obtained in this way is defined as the aspect ratio (L/D) of the macro concave-convex portion.

The opening diameter (D) is usually 20 μm to 200 μm, preferably 40 μm to 180 μm, more preferably 60 μm to 150 μm, and further preferably 80 μm to 120 μm. When the opening diameter (D) is the above lower limit value or larger, the concave portion is widened, and accordingly, the resin of the sealing member 70 to be bonded tends to easily enter the concave portion, and the aspect ratio which will be described later tends to be easily satisfied. On the other hand, when the opening diameter (D) is the above upper limit value or smaller, the fitting effect due to the entering of the resin tends to be easily exhibited, and the aspect ratio which will be described below tends to be easily satisfied.

The depth (L) is usually 20 μm to 200 μm, preferably 40 μm to 180 μm, more preferably 60 μm to 150 μm, and further preferably 80 μm to 120 μm. When the depth (L) is the above lower limit value or larger, the fitting effect due to the entering of the resin tends to be easily exhibited, because the concave portion has a sufficient depth, and the aspect ratio which will be described later tends to be easily satisfied. On the other hand, when the depth (L) is the above upper limit value or smaller, a coarse concave-convex structure is prevented from being formed due to an increase in both the depth (L) value and the opening diameter (D), the fitting effect due to the entering of the resin tends to be easily exhibited, and the aspect ratio which will be described later tends to be easily satisfied.

In addition, the aspect ratio (L/D) of the opening diameter (D) to the depth (L) is usually 0.5 to 5, preferably 0.5 to 4, more preferably 0.7 to 3, and further preferably 1 to 2. Due to such an aspect ratio being satisfied, the resin flows into a deep portion of the concave portion, and suppresses the generation of a void between the macro concave-convex portion and the resin, and can seal the whole surface of the hydroxyl group-containing film. In this way, the concave portion becomes such a shape that the fitting between the terminal member 30 or the closing member 20 and the resin of the sealing member 70 via the macro concave-convex portion is sufficiently exhibited, and thereby, can enhance the bonding strength and airtightness thereof. When the L/D exceeds the above lower limit value, the depth is not relatively too small with respect to the opening diameter of the concave portion, and the concave portion has a shape having an appropriate depth, and tends to easily become a shape in which the fitting between each member and the resin is exhibited when the resin has flowed into the concave portion. In addition, due to the aspect ratio being smaller than the above upper limit value, the depth is not relatively too large with respect to the opening diameter of the concave portion, the width of the concave portion is gradually narrowed from the opening portion toward the deep portion to form a substantially triangular shape, and the resin tends to easily flow into the deep portion of the concave portion.

### <Fine Concave-Convex Portion>

The fine concave-convex portion is a structure having a concave-convex shape of a nm order size, and is formed on the macro concave-convex portion of the surface of the hydroxyl group-containing film. The fine concave-convex portion is formed on the surface of the hydroxyl group-containing film, when the molten metal layer having the hydroxyl group-containing film has been formed by laser irradiation. The fine concave-convex portion can be confirmed by observation of the surface or the cross section of the metal member with the use of a scanning electron microscope, for example.

The fine concave-convex portion has a fine structure in which fine openings are formed which are nano sizes of 10 nm to 50 nm, and the film thickness is from 10 nm to 1000 nm. When having been observed by SEM, the fine concave-convex portion is observed as a spongy structure having fine openings of the above size. The fine concave-convex portion contains a metal hydroxide or a metal oxide hydroxide, similarly to the hydroxyl group-containing film. In addition, the fine concave-convex portion may contain a metal oxide similarly to the hydroxyl group-containing film.

### [1-3. Method for Producing Battery Closing Body]

The method for producing the battery closing body 1 of the present invention includes a member preparation step of sandwiching a gasket member 80 molded in advance between an outer peripheral portion of a terminal member 30 and an inner peripheral portion of a hole part 26 of a closing member 20. The member preparation step includes a step of preparing each of the terminal member 30, the closing member 20, and the gasket member 80. The method for producing the battery closing body 1 of the present invention includes an injection molding step of injection-molding a sealing member 70 in a state in which the terminal member 30, the gasket member 80 and the closing member 20 which have been prepared in the member preparation step are in close contact with each other. In addition, the method for producing the battery closing body 1 of the present invention may include a film forming step of forming a bonding surface on which a hydroxyl group-containing film containing a hydroxyl group is formed on each of the surfaces of the terminal member 30 and the closing member 20, by laser treatment of irradiating the surfaces with laser light; and may perform the member preparation step and the injection molding step with the use of the closing member 20 and the terminal member 30 which have been obtained after the film forming step has been performed.

### <Member Preparation Step>

In the member preparation step, firstly, the closing member 20, the terminal member 30 and the gasket member 80 are prepared by being molded and processed into predetermined shapes in advance, by a molding method and a processing method suitable for the respective metals or resin materials. Then, the gasket member 80 is sandwiched between the outer peripheral portion of the terminal member 30 and the inner peripheral portion of the hole part 26 of the closing member 20 so as to form a stacked state shown in FIG. 3, with the use of the closing member 20, the terminal member 30 and the gasket member 80 which have been prepared. At this time, the terminal member 30 is arranged in such a state that at least one part thereof is exposed on one main surface side of the closing member 20. In addition, each member is appropriately arranged so that a space serving as an air layer is not formed because the sealing member 70 to be molded in the next injection molding step does not enter. In addition, in order to prevent hydrogen fluoride that may be generated from the electrolytic solution on the other main surface side (inside the battery) from coming into contact with the sealing member 70 after having been molded, the gasket member 80 is appropriately sandwiched between the closing member 20 and the terminal member 30 so that the sealing member 70 is separated by the closing member 20 and the terminal member 30.

### <Injection Molding Step>

In the injection molding step, firstly, the closing member 20, the terminal member 30, and the gasket member 80 which have been prepared or arranged in the member preparation step are set in a mold for injection molding. Next, a resin material for injection molding is prepared by melting a resin material containing a second thermoplastic resin and, if necessary, a filler, which is used for the sealing member 70. Then, in a state in which the above members are set, the above resin material is injected into the cavity of the mold from one main surface side (battery outer side) by injection molding so as to form a predetermined shape of the sealing member 70. As for the injection molding conditions, the resin temperature, the mold temperature and the like can be appropriately set according to the resin material containing the second thermoplastic resin to be used. After the injection molding step has been performed, a cooling and solidifying step is performed which cools a molten or plasticized resin material while applying a pressure. After that, the method includes a taking-out step of opening the mold for the injection molding, and taking out the battery closing body 1 of a molded product.

Due to such an injection molding step, the sealing member 70 is injection-molded so as to cover the outer peripheral portion of the terminal member 30, the gasket member 80, and the inner peripheral portion of the closing member 20 on the one main surface side, and the terminal member 30, the gasket member 80 and the closing member 20 are integrated in a close contact state, as is shown in FIG. 3. In addition, it is desirable that the sealing member 70 is integrated with the terminal member 30, the gasket member 80 and the closing member 20, in a state of being bonded to each of the members. In other words, the sealing member 70 is injection-molded so as to cover the whole surface exposed on the one main surface side except for the portion in contact with the gasket member 80 in the outer peripheral portion of the terminal member 30; and accordingly, the airtightness and the watertightness are enhanced, and the adhesive strength is enhanced. In addition, the production (assembly and injection molding) is facilitated.

### <Film Forming Step>

In the film forming step, before each of the members is arranged in the member preparation step, surfaces of portions at which a prepared closing member 20 and terminal member 30 that can be brought into close contact (bonded) with the sealing member 70 are subjected to treatment of being irradiated with laser light (hereinafter simply referred to as “laser treatment” or the like). By the laser treatment, the bonding surface 27 and the bonding surface 36 of the closing member 20 and the terminal member 30 with the sealing member 70 are formed. In addition, the bonding surface 27 and the bonding surface 36 on which the hydroxyl group-containing film has been formed are formed by the laser treatment.

Specifically, when the bonding surface 27 and the bonding surface 36 are formed at predetermined portions of the closing member 20 and the terminal member 30, respectively, the bonding surface 27 and the bonding surface 36 are formed by subjecting the surface of the outer peripheral portion of the terminal member 30 (for example, first step bottom surface 34 (32)) and the inner peripheral portion of the closing member 20 on the one main surface side (battery outer side), which is to be injection-molded, to the laser treatment, respectively. In addition, in the member preparation step, the terminal member 30 and the closing member 20 are arranged so that the bonding surface 36 formed on the terminal member 30 and the bonding surface 27 formed on the closing member 20 are in a state of being exposed toward the one main surface side. In addition, in the injection molding step, it is preferable that the resin of the sealing member 70 is injection-molded so as to cover the bonding surface 27 and the bonding surface 36 of the terminal member 30 and the closing member 20, on the one main surface side. By doing in this way, the bonding surface 27 and the bonding surface 36 having the hydroxyl group-containing film are formed on the one main surface side which is covered with the sealing member 70, and thereby, a sufficient bonding strength and airtightness can be expected to be exhibited. In addition, due to the laser treatment being performed from only one main surface side, the bonding surface 27 and the bonding surface 36 can be formed, which are expected to exhibit a sufficient bonding strength and airtightness; and it is not necessary to perform the laser treatment on the whole of portions of the terminal member 30 and the closing member 20, which will come in contact with the sealing member 70, and accordingly, the time required for the laser treatment can be shortened and the production efficiency can be improved.

As the laser, a known laser can be used, but it is preferable to use a pulse oscillation laser because the pulse oscillation laser is convenient for processing each member in a form of spots as in the present invention, and for example, a YAG laser, a YVO₄ laser, a semi-conductor laser and a fiber laser may be used.

The principle of formation of the hydroxyl group-containing film is generally as follows. Specifically, each member formed from metal is melted and evaporated by the energy of the laser irradiation, and a hole is formed by the evaporation; and thereby, the resultant space becomes the base of the concave portion, and the portions on both sides (both adjacent sides) of the concave portion, which have not been irradiated with the laser, become the base of the convex portion. At the same time, the melted metal portion is partially or entirely oxidized and forms a metal oxide; and the metal oxide deposits around the irradiated portion to be a concave portion, and thereby, a convex portion is formed. The deposit formed from the metal oxide is formed in a film shape while covering the concave portion and the convex portion. Due to the deposit formed from the metal oxide formed in this way, a molten metal layer is formed which forms the concave-convex shape of the macro concave-convex portion. Furthermore, the metal oxide has at least somewhat partially ionic properties, and metallic ions (Al³⁺) and oxidic ions (O²⁻) exist on the new surface of the metal oxide. Due to the electrostatic neutralization property, the metal oxide existing on the surface of the molten metal layer reacts with moisture in the air, and is hydroxylated; and the surface of the molten metal layer results in being covered with the hydroxyl group. In this way, a hydroxyl group-containing film containing the hydroxyl group is formed on the outermost layer of the molten metal layer.

For information, in the case where a laser-unirradiated portion exists which is not irradiated with laser light, the molten metal layer does not exist in the laser-unirradiated portion, and the hydroxyl group-containing film does not also exist there. Usually, an oxide film is formed on the laser-unirradiated portion. The laser-unirradiated portion does not have the macro concave-convex portion, and accordingly, is usually flat; accordingly, when a resin or the like is bonded to the portion, the bonding strength is not expected to be improved by mechanical bonding caused by the macro concave-convex portion; and a void tends to be easily formed because the portion is flat, and accordingly, also the airtightness cannot be expected to be improved. Accordingly, in the case where the laser-unirradiated portion remains on the bonding surface and the hydroxyl group-containing film is not formed on the whole bonding surface, there is a possibility that the airtightness and the bonding strength are lowered on the bonding surface 27 and the bonding surface 36. For information, in the laser-unirradiated portion, the above hydroxyl group-containing film does not exist, and accordingly, the interaction by chemical bonding cannot be also expected which is caused by the hydroxyl group.

### <Laser Treatment Conditions>

In order that the bonding surface is configured to have the hydroxyl group-containing film having the macro concave-convex portion and the fine concave-convex portion as described above, it is preferable to set laser treatment conditions in consideration of the following points.

The laser treatment is affected by the irradiation energy of the laser light per unit area (hereinafter also referred to as “energy density”). The energy density represents a laser output which a laser irradiated portion that is irradiated with laser light receives per unit area and unit time, in an object (workpiece) to be subjected to the laser treatment. The energy density (J/mm²) is expressed by the following Expression (A1) from an output W (W) of the laser light, the number of scans N (times) of the laser light, an irradiation interval C (mm) of the laser light, a scanning speed V (mm/s) of the laser light, a length Length of the laser irradiated portion in a direction perpendicular to the irradiation direction of the laser light, and a width Width of the laser irradiated portion in a direction parallel to the irradiation direction of the laser light.

$$Energy density = ( ( ( Length / C ) \times Width ) \times N ) / V ) \times W ) / ( Length \times Width ) \qquad Expression ( A1 )$$

The following Expression (A2) is obtained by transforming the Expression (A1). The energy density can be calculated by the Expression (A2).

$$Energy density = ( W \times N ) / ( C \times V ) \qquad Expression ( A2 )$$

The energy density is preferably 0.5 J/mm² or higher. When the energy density increases, the fine concave-convex portion having a hydroxyl group tends to be easily formed on the surface of each member formed from metal which has been subjected to the laser treatment. In addition, a hydroxyl group-containing film having a predetermined abundance ratio of hydroxyl group tends to be easily formed. Furthermore, when the energy density increases, the concave portion of the macro concave-convex portion to be formed is formed deeply, and the surface roughness after the laser treatment tends to become large. For information, as the melting point of the metal constituting each member formed from metal is higher and thermal diffusion is larger, the metal tends to be less affected by the laser light. In consideration of the above-described circumstances, it is desirable to change the energy density so as to match the metal to be subjected to the laser treatment.

In the case where each member formed from metal of which the main metal is aluminum is subjected to the laser treatment, the energy density is preferably 0.5 J/mm² or higher, is more preferably 1 J/mm² or higher, and is further preferably 1.5 J/mm² or higher. In addition, in the case where each member formed from metal of which the main metal is aluminum is subjected to the laser treatment, the energy density is preferably 5 J/mm² or lower, is more preferably 4 J/mm² or lower, and is further preferably 3 J/mm² or lower.

In the case where each member formed from metal of which the main metal is iron is subjected to the laser treatment, the energy density is preferably 1 J/mm² or higher, is more preferably 2 J/mm² or higher, and is further preferably 3 J/mm² or higher. In addition, in the case where each member formed from metal of which the main metal is iron is subjected to the laser treatment, the energy density is preferably 10 J/mm² or lower, is more preferably 8 J/mm² or lower, and is further preferably 6 J/mm² or lower.

In the case where each member formed from metal of which the main metal is copper is subjected to the laser treatment, the energy density is preferably 2 J/mm² or higher, is more preferably 4 J/mm² or higher, and is further preferably 6 J/mm² or higher. In addition, in the case where each member formed from metal of which the main metal is copper is subjected to the laser treatment, the energy density is preferably 20 J/mm² or lower, is more preferably 15 J/mm² or lower, and is further preferably 10 J/mm² or lower.

When the energy density is the above lower limit value or higher, the fine concave-convex portion having a hydroxyl group tends to be easily formed on the surface of each member formed from metal, which has been subjected to the laser treatment. In addition, a hydroxyl group-containing film having a predetermined abundance ratio of the hydroxyl group tends to be easily formed. Accordingly, the airtightness and the bonding strength at the bonding surface 27 and the bonding surface 36 tend to be easily improved, by the fine concave-convex portion having the hydroxyl group and the hydroxyl group-containing film. In addition, when the energy density is the above lower limit value or higher, the depth (L) of the concave portion of the macro concave-convex portion to be formed tends to increase, and the aspect ratio (L/D) tends to increase. Accordingly, the resin of the sealing member 70 enters the macro concave-convex portion, thereby, mechanical bonding (anchor effect) between the macro concave-convex portion and the sealing member 70 is exhibited, and thereby, the bonding strength tends to be easily improved. When the energy density is the above upper limit value or lower, it becomes easy to prevent the depth (L) of the concave portion of the macro concave-convex portion to be formed from being excessively large, and prevent the aspect ratio (L/D) thereof from being excessively large. Accordingly, the resin can enter the deep portion of the concave portion of the macro concave-convex portion, and the chemical bonding between the hydroxyl group of each member formed from metal and the functional group of the sealing member 70 is exhibited in the whole macro concave-convex portion; and thereby the airtightness tends to be easily improved. In addition, it is possible to prevent the structure of the convex portion of the macro concave-convex portion from having an elongated and pointed shape, and to suppress a decrease in mechanical strength due to the convex portion being broken or the like. In addition, it is possible to prevent breakage from occurring in each member formed from metal, when the bonded portion is broken.

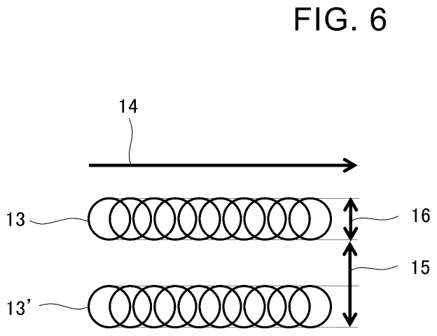

The laser conditions (laser treatment conditions) in the laser treatment may be appropriately set so that the above-described energy density is achieved. Examples of the parameters of the laser treatment conditions include the output (W) of the laser light, the frequency (kHz) of the laser light, the beam diameter (μm) of the laser light, the irradiation interval (μm) of the laser light, the scanning speed (mm/s) of the laser light, and the number of scans (times) of the laser light. For information, the number of scans refers to the number of times of repeated irradiation with laser light along the same irradiation trajectory. Here, the relationship between the beam diameter of the laser light and the irradiation interval will be described with reference to FIG. 6. The irradiation interval of the laser light refers to an interval between a trajectory 13 of one laser light emitted to an object and a trajectory 13′ of another laser light to be emitted adjacently to the laser. More specifically, the irradiation interval of the laser light refers to a distance between an end portion of the trajectory 13 of the one laser light on one side in a direction orthogonal to the scanning direction 14 and an end portion of the trajectory 13′ of the other laser light on the same side as the one laser light. When a pulsed laser is emitted, the trajectory of the laser light is shown as a trajectory in which the pores formed by the individual laser pulses are continuous. In this case, the irradiation interval 15 of the laser light corresponds to the length obtained by adding the width of the region sandwiched by the trajectories of the laser light, which are formed by the continuous pores, to the size of the beam diameter 16. Table 1 shows examples of laser treatment conditions, in the case where the main metal of the metal base material to be subjected to the laser treatment is aluminum, iron, or copper.

TABLE 1

| | Aluminum | Iron | Copper |
|---|---|---|---|
| Output (W) | 20-500 | 20-500 | 20-500 |
| Frequency (kHz) | 30-200 | 30-200 | 30-200 |
| Beam diameter (μm) | 20-200 | 20-200 | 20-200 |
| Irradiation interval (μm) | 20-200 | 20-200 | 20-200 |
| Scanning speed (mm/s) | 200-5000 | 200-5000 | 200-5000 |
| Number of scans (times) | 1-20 | 1-20 | 1-20 |
| Energy density (J/mm²) | 0.5-5 | 1-10 | 2-20 |

### 2. Embodiment 2

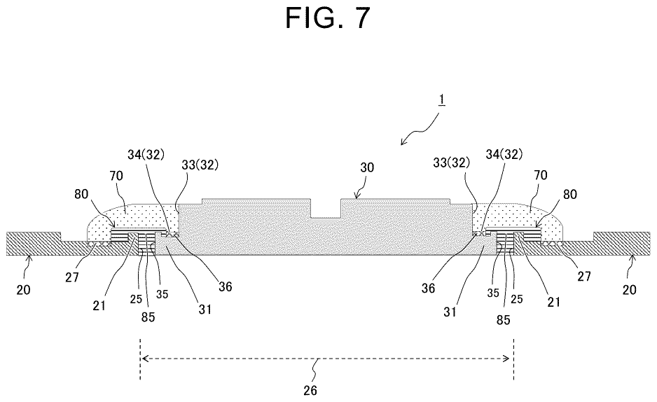

FIG. 7 shows a cross-sectional view of a battery closing body 1 according to an embodiment 2 of the present invention.

As shown in FIG. 7, in the battery closing body 1 according to the embodiment 2, the terminal member 30 is inserted into the hole part 26 of the closing member 20. Thereby, an outer peripheral end surface (outer peripheral side surface) 35 of the outer peripheral portion (first flange portion 31) of the terminal member 30 and an inner peripheral end surface (inner peripheral side surface) 25 of the hole part 26 of the closing member 20 are arranged so as to face each other while sandwiching the gasket member 80 therebetween. In addition, the upper surface (first step bottom surface 34 (32)) of the outer peripheral portion (first flange portion 31) of the terminal member 30, the upper surface of the gasket member 80, and a part of the upper surface of the flat portion of the closing member 20, which are arranged in the above way, are integrated by the sealing member 70 while coming in close contact with each other without allowing a space serving as an air layer to exist.

For information, in the embodiment 2, the other parts are the same as those in the embodiment 1, accordingly, the same parts are denoted by the same reference numerals, and the description thereof is omitted.

In addition, due to the terminal member 30, the closing member 20 and the gasket member 80 being arranged in this way, these members can be arranged side by side along a planar direction of the main body part of the closing member 20. Thereby, the battery closing body can be formed so that its height becomes relatively low, and can lower the height.

In addition, the outer peripheral portion (first step side surface 33 (32), a first step bottom surface 34 (32)) of the terminal member 30, the gasket member 80, and a flat portion of the closing member 20 outside the gasket member 80, which are arranged along the planar direction, are covered and integrated with the sealing member 70, and accordingly, the sealing member 70 is provided on the one main surface side of the closing member 20; and thereby, when an electrolytic solution exists on the other surface side (battery inner side), the sealing member 70 is separated by the terminal member 30, the gasket member 80 and the closing member 20, and the sealing member 70 can avoid the possibility of being exposed to the electrolytic solution.

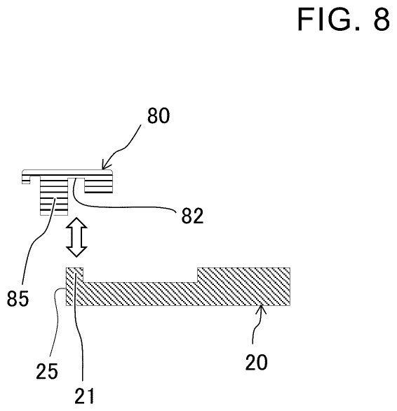

As shown in FIGS. 7 and 8, the gasket member 80 of the embodiment 2 has an annular shape in a plan view, and includes: an intermediate portion 85 that extends in a thickness direction; an inner peripheral portion that expands from the intermediate portion 85 in the inner peripheral direction and comes in contact with the upper surface (first step bottom surface 34 (32)) of the first flange portion 31 of the terminal member 30; and an outer peripheral portion that expands from the intermediate portion 85 in the outer peripheral direction, and forms a concave portion 82 having an inner wall surface that comes in contact with one main surface side (battery outer side) of the flat portion while surrounding the protruding portion 21 of the inner peripheral portion of the closing member 20. In this way, the closing member 20 has the protruding portion 21 that protrudes in the thickness direction in the vicinity of the inner peripheral portion; and the gasket member 80 has the concave portion 82 which is recessed in the thickness direction. Then, the gasket member is sandwiched in a state in which the protruding portion 21 of the closing member 20 and the concave portion 82 of the gasket member 80 are fitted to each other so as to come in close contact with each other. Thereby, the positioning of the gasket member 80 to the closing member 20 is facilitated at the time of assembly. In addition, it becomes easy to prevent the gasket member 80 from moving at the time of injection molding.

Furthermore, the intermediate portion 85 of the gasket member 80 is sandwiched between the outer peripheral end surface (outer peripheral side surface) 35 of the terminal member 30 and the inner peripheral end surface (inner peripheral side surface) 25 of the closing member 20 from the left and right. Thereby, the terminal member 30, the gasket member 80 and the closing member 20 are arranged in close contact with each other in a planar direction, and accordingly, as in the above, the sealing member 70 can avoid the possibility of being exposed to the electrolytic solution, and also, the sealing member 70 can be injection-molded in a state in which each of the members come in close contact with each other.

In addition, similarly to the embodiment 1, it is preferable that the bonding surface 27 and the bonding surface 36 each having the hydroxyl group-containing film, the macro concave-convex portion and the fine concave-convex portion are formed at the interfaces in which the closing member 20 and the terminal member 30 come in close contact with the sealing member 70. In the present embodiment, the bonding surface 36 is formed on the upper side (first step bottom surface 34 (32)) of the first flange portion 31 of the terminal member 30, which is a portion in the inner peripheral direction from the position of the gasket member 80. In addition, the bonding surface 27 is formed in a portion in the vicinity of inner peripheral end surface (inner peripheral side surface) 25 of the hole part 26 of the closing member 20, which is the outer peripheral direction relative to the position of the gasket member 80. The bonding surface 27 and the bonding surface 36 can be formed by the laser treatment in the film forming step as described in the embodiment 1.

The method for producing a battery closing body of the embodiment 2 includes: as in the embodiment 1, a member preparation step of preparing the closing member 20, the terminal member 30 and the gasket member 80, and arranging the members at predetermined positions; and after the member preparation step, an injection molding step of injection-molding the resin of the sealing member 70 so that the sealing member 70 and each of these members come in close contact with each other without existence of a space that forms an air layer therebetween. In addition, the method may include a film forming step of forming the bonding surface 27 and the bonding surface 36 at predetermined positions of the closing member 20 and the terminal member 30 before the member preparation step, similarly to the embodiment 1.

### 3. Embodiment 3

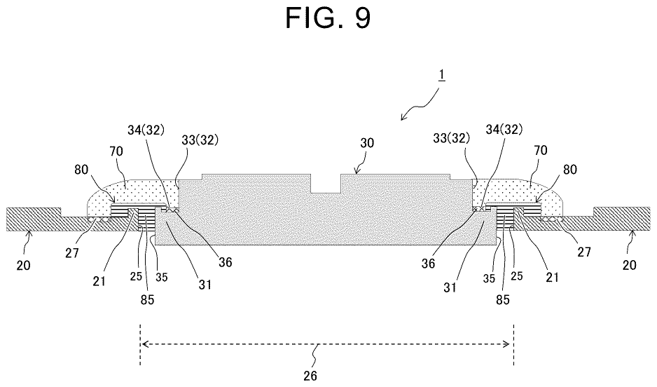

FIG. 9 shows a cross-sectional view of the battery closing body 1 according to an embodiment 3 of the present invention.

In the battery closing body 1 of the embodiment 3, the lower portion of the closing member 20 (whole lower surface of main body part and first flange portion 31) of the terminal member 30 of the embodiment 2 penetrates to the other main surface side (battery inner side) through the hole part 26. In other words, in the embodiment 3, the terminal member 30 has a form in which the upper portion and the lower portion thereof protrude toward both main surface sides of the closing member 20. Because the terminal member 30 has such a shape, the portion of the terminal member 30 penetrating the closing member 20 facilitates conduction with the member inside the battery. In FIG. 9, the whole of the lower portion of the terminal member 30 is illustrated as a shape which extends in a columnar shape toward the other main surface side of the closing member 20, but the shape of the lower portion of the terminal member is not limited to this shape. For example, the lower portion of the terminal member 30 may be extended by a plate shape, a columnar shape, or a conical shape; or a part of the lower portion of the terminal member 30 may be extended. In addition, it is acceptable that a member inside the battery is connected to the lower portion which has been extended in this way, and is conducted thereto.

In the embodiment 3, the other parts are the same as those in the embodiment 2, and accordingly, the same parts are denoted by the same reference numerals and the description thereof will be omitted. The configuration and the operation and effect of the embodiment 3 other than the terminal member 30 are the same as those of the embodiment 2.

### 4. Embodiment 4

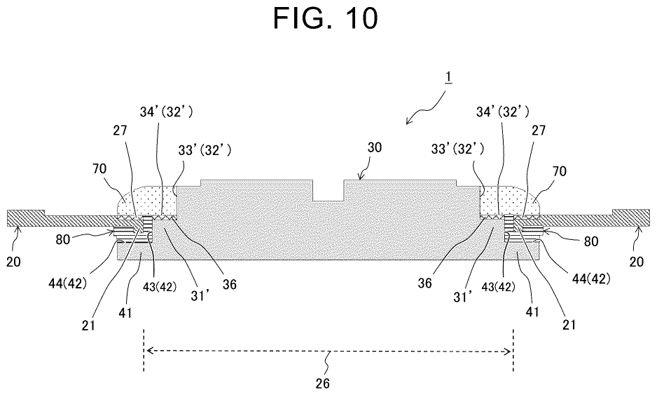

FIG. 10 shows a cross-sectional view of the battery closing body 1 according to an embodiment 4 of the present invention.

As shown in FIG. 10, in the battery closing body 1 according to the embodiment 4, the terminal member 30 has a first flange portion 31′ corresponding to the first flange portion 31 in the embodiments 1 to 3, and also has a second flange portion 41 that further protrudes and expands in the outer peripheral direction from the first flange portion 31′, in the outer peripheral portion.

Due to having the first flange portion 31′, a first step portion 32′ is formed that is composed of a first step side surface 33′ (32′) which is a side surface of the central portion, and a first step bottom surface 34′ (32′) which is an upper surface of the first flange portion 31′. In addition, due to having the second flange portion 41, a second step portion 42 is formed that is composed of a second step side surface 43 (42) which is a side surface of the first flange portion 31′, and a second step bottom surface 44 (42) which is an upper surface of the second flange portion 41.

The closing member 20 includes a planar flat surface portion, and a protruding portion 21 which protrudes toward the other main surface side (battery inner side), in a periphery of the hole part 26 of the closing member 20.

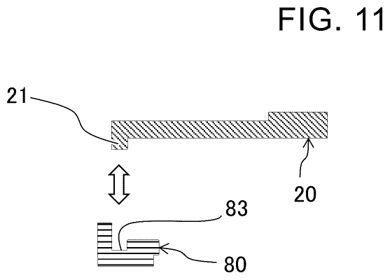

The gasket member 80 is arranged on the second step portion 42 formed by the second flange portion 41 of the terminal member 30. Specifically, the gasket member 80 is configured to be arranged in close contact with the second step side surface 43 (42) and the second step bottom surface 44 (42) of the second step portion 42 along a part or the whole of the surfaces so as to cover a part or the whole of the second step portion 42. In addition, as shown in FIG. 11, the gasket member 80 has a concave portion 83 into which the protruding portion 21 of the closing member 20 is fitted, so as to match the shape of the protruding portion 21.

Then, the closing member 20 is arranged on the gasket member 80 which has been arranged on the second step portion 42 formed by second flange portion 41 of the terminal member 30. As shown in FIGS. 10 and 11, the closing member 20 is arranged so that the protruding portion 21 is fitted into the predetermined concave portion 83 of the gasket member 80. At this time, the second step side surface 43 (42) which is the outer peripheral side end surface of the first flange portion 31′ of the terminal member 30, and the inner peripheral side end surface of the hole part 26 of the closing member 20 (in FIG. 10, inner peripheral side surface of protruding portion 21) are arranged so as to face each other in the left-right direction (horizontal direction) while sandwiching the gasket member 80 therebetween. Furthermore, at this time, the second step bottom surface 44 (42) which is the outer peripheral upper end surface of the second flange portion 41 of the terminal member 30, and the lower end surface of the inner peripheral portion of the hole part 26 of the closing member 20 (in FIG. 10, lower surface of inner peripheral portion of hole part 26 including protruding portion 21) are arranged so as to face each other in the vertical direction (thickness direction) while sandwiching the gasket member 80 therebetween.

The gasket member 80 has an annular shape in a plan view, and includes: an outer peripheral portion in contact with a lower surface of the closing member 20 positioned on the other main surface side of the outer periphery relative to the protruding portion 21 of the closing member 20; and an inner peripheral portion that expands from the outer peripheral portion toward the inner peripheral direction, and also forms the concave portion 83 having an inner wall surface in contact with the outer peripheral side surface of the protruding portion 21, the tip end surface of the protruding portion 21 and the inner peripheral side surface of the protruding portion 21. In this way, the closing member 20 has the protruding portion 21 that protrudes in the thickness direction in the vicinity of the inner peripheral portion, and the gasket member 80 has the concave portion 83 that is recessed in the thickness direction. In addition, the gasket member 80 is sandwiched in a state in which the protruding portion 21 of the closing member 20 and the concave portion 83 of the gasket member 80 are fitted to each other so as to come in close contact with each other. Thereby, the positioning of the gasket member 80 to the closing member 20 is facilitated at the time of assembly. In addition, it becomes easy to prevent the gasket member 80 from moving at the time of injection molding.

Furthermore, the outer peripheral portion of the gasket member 80 is sandwiched from above and below between the second step bottom surface 44 (42) of the second flange portion 41 of the terminal member 30 and the lower end surface of the closing member 20 on the outer periphery side relative to the protruding portion 21. In addition, the vicinity of the tip end surface of the protruding portion 21 in the inner peripheral portion of the gasket member 80 is sandwiched from above and below between the second step bottom surface 44 (42) of the second flange portion 41 of the terminal member 30 and the tip end surface of the protruding portion 21 of the closing member 20. In addition, a part of the inner peripheral portion of the gasket member 80 is sandwiched between the second step side surface 43 (42) of the terminal member 30 and the protruding portion 21 of the closing member 20, from the left and right (horizontal direction). Due to having the portion sandwiched from above and below, in the case where the internal pressure has risen when the battery is used, and the terminal member 30 has been pressed toward the outside of the battery, the second flange portion 41 serves as a stopper, and thereby the terminal member 30 can be prevented from coming off from the battery container. In addition, due to having the portion sandwiched from the left and right (horizontal direction), in the case where the internal pressure of the battery has risen and the terminal member 30 has been pressed toward the outside of the battery, the second flange portion 41 presses the gasket member 80 sandwiched between the second flange portion 41 and the closing member 20, thereby, the gasket member 80 is brought into close contact with each of the terminal member 30 and the closing member 20, and the airtightness can be maintained.

In addition, in the outer peripheral portion of the terminal member 30, the terminal member 30, the closing member 20, and the gasket member 80 are arranged in this way; and thereby, the outer peripheral portion of the terminal member 30 is arranged so that the first flange portion 31′ is inserted into the hole part 26 of the closing member 20, and the second flange portion 41 positioned lower than the first flange portion 31′ is arranged so as to protrude and expand from the lower surface side of the hole part 26 of the closing member 20 in the outer peripheral direction, on the battery inner side.

Similarly to the embodiments 1 to 3, the sealing member 70 is injection-molded from one main surface side (battery outer side), and thereby, is arranged so as to cover the first step portion 32′ (first step side surface 33′ (32′) and first step bottom surface 34′ (32′)) of the terminal member 30, the gasket member 80 (upper surface of portion sandwiched between terminal member 30 and closing member 20 in horizontal (left-right) direction), and the upper surface of the inner peripheral portion of the hole part 26 of the closing member 20 (inner peripheral portion of protruding portion 21 in FIG. 10), from the main surface side. The sealing member 70 is injection-molded in a state in which these members are in close contact with each other without existence of a space that forms an air layer, between each of these members

In addition, similarly to the embodiments 1 to 3, it is preferable that the bonding surface 27 and the bonding surface 36 each having the hydroxyl group-containing film, the macro concave-convex portion and the fine concave-convex portion are formed at the interface at which the closing member 20 and the terminal member 30 come e in close contact with the sealing member 70.

Specifically, as is shown in FIG. 10, the bonding surface 36 is formed on the first step bottom surface 34′ (32′) of the first flange portion 31′ of the terminal member 30. In addition, the bonding surface 27 is formed on the upper surface of the inner peripheral portion of the hole part 26 of the closing member 20. Similarly to the above, the bonding surface 27 and the bonding surface 36 can be formed by the laser treatment in the film forming step.

The method for producing a battery closing body of embodiment 4 is performed in the same way as in the embodiments 1 to 3.

### 5. Embodiment 5

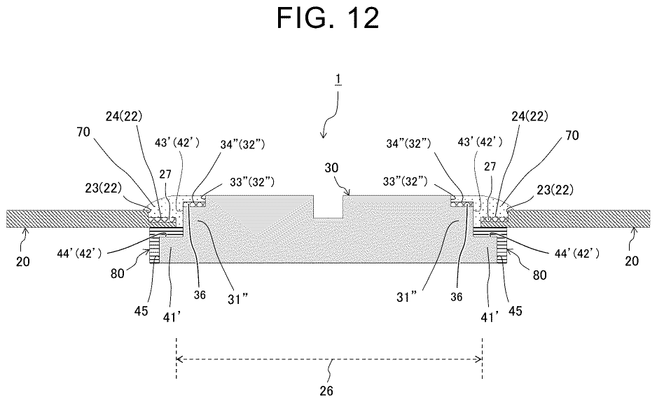

FIG. 12 shows a cross-sectional view of a battery closing body 1 according to an embodiment 5 of the present invention.

As is shown in FIG. 12, in the battery closing body 1 according to the embodiment 5, the terminal member 30 has a first flange portion 31″ corresponding to the first flange portion 31 or 31′ of the embodiments 1 to 4. In addition, the terminal member 30 has a second flange portion 41′ that protrudes and expands further in the outer peripheral direction from the first flange portion 31″, on the outer peripheral portion.

In addition, similarly to the embodiment 4, due to having the first flange portion 31″, a first step portion 32″ is formed that includes a first step side surface 33″ (32″) which is a side surface of the central portion and a first step bottom surface 34″ (32″) which is an upper surface of the first flange portion 31″. In addition, due to having the second flange portion 41′, a second step portion 42′ is formed that is composed of a second step side surface 43′ (42′) which is a side surface of the first flange portion 31″, and a second step bottom surface 44′ (42′) which is an upper surface of the second flange portion 41′; and a second flange portion side surface 45 is formed on the outer peripheral portion.

In the first flange portion 31″ of the embodiment 5, it is preferable that the height of the second step side surface 43′ (42′) is lowered. In addition, it is preferable to lower the height of the first step side surface 33″ (32″). Due to lowering the height of these components, the height of the battery closing body 1 can be lowered in combination with the arrangement of the closing member 20, which will be described later. The height of the second step side surface 43′ (42′) is not limited, but in order to lower the height, it is preferable that the height of the first step bottom surface 34″ (32″) is substantially the same as the height of the upper surface of the closing member 20 on the one main surface side (battery outer side) excluding the third step portion 22 which will be described later. In addition, the height of the first step side surface 33″ (32″) is not limited, but in order to lower the height, it is preferable that the height of the upper surface of the terminal member 30 is slightly higher than the upper surface of the closing member 20 on the one main surface side excluding a third step portion 22 which will be described later.

In the embodiment 5, as is shown in FIG. 12, the closing member 20 includes: a planar flat surface portion on the outer peripheral portion side; and the third step portion 22 that is formed by recessing the upper surface of the flat surface portion on one main surface side (battery outer side), in the periphery of the hole part 26 (inner peripheral portion side) of the closing member 20. The third step portion 22 is formed of a third step side surface 23 (22) and a third step bottom surface 24 (22).

The gasket member 80 has an annular shape in a plan view, and includes: an inner peripheral portion in contact with the lower surface of the closing member 20 (lower surface of third step portion 22 in FIG. 12); and an outer peripheral portion that extends downward in the thickness direction from the inner peripheral portion, along the second flange portion side surface 45 of the terminal member 30. In addition, the gasket member 80 is arranged on the second step portion 42′ formed by the second flange portion 41′ of the terminal member 30. A corner portion that is formed by the second step bottom surface 44′ (42′) and the second flange portion side surface 45 of the second flange portion 41′ of the terminal member 30 is abutted against an inner corner that is formed by the inner peripheral portion and the outer peripheral portion of the gasket member 80, thereby the lower surface of the inner peripheral portion of the gasket member 80 abuts on the second step bottom surface 44′ (42′) of the terminal member 30, and the inner side surface of the outer peripheral portion of the gasket member 80 abuts on the second flange portion side surface 45 of the terminal member 30. In other words, the gasket member 80 is configured to be arranged in close contact with and along a part or the whole of the second step side surface 43′ (42′), the second step bottom surface 44′ (42′) and the second flange portion side surface 45 which is the outer peripheral portion of the second flange portion 41′, so as to cover a part or the whole of the second step portion 42′ and also a part or the whole of the second flange portion side surface 45. The corner portion that is formed by the second step bottom surface 44′ (42′) and the second flange portion side surface 45 of the second flange portion 41′ of the terminal member 30 is abutted against an inner corner that is formed by the inner peripheral portion and the outer peripheral portion of the gasket member 80, and thereby the positioning of the gasket member 80 to the terminal member 30 is facilitated at the time of assembly. In addition, it becomes easy to prevent the gasket member 80 from moving at the time of injection molding.

The closing member 20 is arranged on the gasket member 80 that has been arranged on the second step portion 42′ formed by second flange portion 41′ of the terminal member 30, and on the second flange portion side surface 45. The closing member 20 is arranged so that the upper surface of the gasket member 80 arranged as in the above comes in contact with a lower surface of the peripheral portion at which the third step portion 22 of the closing member 20 has been formed. At this time, these members are arranged so that the surfaces thereof in contact with each other come in close contact with each other. In addition, as is shown in FIG. 12, the closing member 20 is arranged so that a portion (gap) into which the sealing member 70 that will be described later enters is provided between the inner peripheral portion of the hole part 26 of the closing member 20 and the second step side surface 43′ (42′) of the terminal member 30. In other words, the gap between the closing member 20 and the terminal member 30 is configured so that the sealing member 70 enters thereinto and forms a portion that comes in close contact with the upper surface of the gasket member 80, which has been exposed to the gap.

Thereby, the second step bottom surface 44′ (42′) which is the outer peripheral upper end surface of the second flange portion 41′ of the terminal member 30, and the lower end surface of the inner peripheral portion of the hole part 26 of the closing member 20 (in FIG. 12, lower surface of portion including third step portion 22) are arranged so as to face each other in the vertical direction (thickness direction) while sandwiching the gasket member 80 therebetween.

In other words, the inner peripheral portion of the gasket member 80 is sandwiched from above and below between the second step bottom surface 44′ (42′) of the second flange portion 41′ of the terminal member 30 and the lower end surface of the inner peripheral portion of the hole part 26 including the third step portion 22 in the closing member 20. Due to having the portion sandwiched from above and below, in the case where the internal pressure has risen when the battery is used, and the terminal member 30 has been pressed toward the outside of the battery, the second flange portion 41′ serves as a stopper, and thereby the terminal member 30 can be prevented from coming off from the battery container. In addition, similarly in the case where the internal pressure of the battery has risen and the terminal member 30 has been pressed toward the outside of the battery, the second flange portion 41′ presses the gasket member 80 sandwiched between the second flange portion 41′ and the closing member 20, thereby, the gasket member 80 is brought into close contact with each of the terminal member 30 and the closing member 20, and the airtightness can be maintained.

In addition, in the outer peripheral portion of the terminal member 30, the terminal member 30, the closing member 20, and the gasket member 80 are arranged in this way; and thereby, the outer peripheral portion of the terminal member 30 is arranged so that the first flange portion 31″ is inserted into the hole part 26 of the closing member 20, and the second flange portion 41′ positioned lower than the first flange portion 31″ is arranged so as to protrude and expand from the lower surface side of the hole part 26 of the closing member 20 in the outer peripheral direction, on the battery inner side.

Similarly to the embodiments 1 to 4, the sealing member 70 is injection-molded from one main surface side (battery outer side), and thereby is arranged so as to cover the first step portion 32″ (first step side surface 33″ (32″) and first step bottom surface 34″ (32″)) of the terminal member 30, the second step side surface 43′ (42′) which is a side surface of the first flange portion 31″, an upper surface of the gasket member 80 (surface exposed to gap formed between terminal member 30 and closing member 20), and an upper surface of an inner peripheral portion of the hole part 26 of the closing member 20 (in FIG. 12, portion including third step portion 22 and flat surface portion continuous from third step portion 22), from the main surface side. The sealing member 70 is injection-molded in a state in which these members are in close contact with each other without a space that forms an air layer, between each of these members.

In addition, similarly to the embodiments 1 to 4, it is preferable that the bonding surface 27 and the bonding surface 36 each having the hydroxyl group-containing film, the macro concave-convex portion and the fine concave-convex portion are formed at the interface at which the closing member 20 and the terminal member 30 come in close contact with the sealing member 70. Specifically, in the embodiment 5, as is shown in FIG. 12, the bonding surface 36 is formed on the first step bottom surface 34″ (32″) of the first flange portion 31″ of the terminal member 30. In addition, the bonding surface 27 is formed on the inner peripheral portion of the hole part 26 of the closing member 20, which is the third step bottom surface 24 (22) of the third step portion 22. Similarly to the above, the bonding surface 27 and the bonding surface 36 can be formed by the laser treatment in the film forming step.

In the embodiment 5, the height of the first step side surface 33″ (32″) of the first step portion 32″ is relatively lowered, and thus the height can be lowered. In this case, as in the above, due to the third step portion 22 being provided in the closing member 20, the amount of the resin of the sealing member 70 can be increased, which is filled in the second step portion 42′ and the third step portion 22, for sealing the closing member 20, the terminal member 30 and the gasket member 80, in correspondence with the volume of the portion around the inner peripheral portion of the closing member 20, at which the thickness has been thinned by the third step portion 22. Thereby, even when the height of the first step side surface 33″ (32″) is low, and the amount of the resin of the sealing member 70 becomes small which is injection-molded to the first step portion 32″, the amount of the resin of the sealing member 70 can be sufficient which is injection-molded between the third step portion 22 and the second step portion 42′. In addition, thereby, it is possible to increase the breaking strength of the base material, and particularly increase the bonding strength between the sealing member 70 and each of the terminal member 30 and the closing member 20.

The method for producing the battery closing body 1 of the embodiment 5 is performed in the same way as in the embodiments 1 to 4.

### 6. Embodiment 6

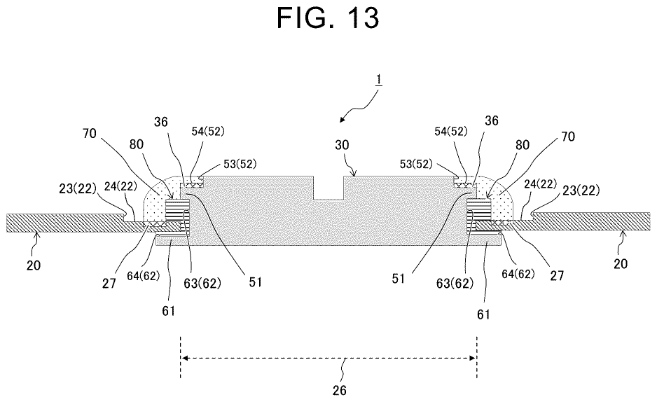

FIG. 13 shows a cross-sectional view of a battery closing body 1 according to an embodiment 6 of the present invention.

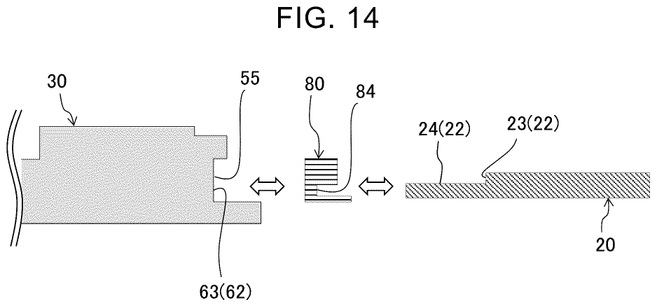

As is shown in FIGS. 13 and 14, in the battery closing body 1 according to the embodiment 6, the terminal member 30 includes: a generally columnar central portion; a circumferential convex portion 51 that is lowered by one step in the outer peripheral portion of the central portion and protrudes and expands from the central portion in the outer peripheral direction; a circumferential concave portion 55 that is lower than the circumferential convex portion 51 and is recessed inward in the inner peripheral direction from the circumferential convex portion 51; and a fifth flange portion 61 that protrudes and expands from the circumferential concave portion 55 in the outer peripheral direction.

In the embodiment 6, due to having the circumferential convex portion 51, a fourth step portion 52 is formed that is composed of a fourth step side surface 53 (52) which is the side surface of the central portion, and a fourth step bottom surface 54 (52) which is the upper surface of the circumferential convex portion 51. In addition, due to having the fifth flange portion 61 from the circumferential concave portion, a fifth step portion 62 is formed that is composed of a fifth step side surface 63 (62) which is a side surface of the circumferential concave portion 55, and a fifth step bottom surface 64 (62) which is an upper surface of the fifth flange portion 61.

In the embodiment 6, as is shown in FIGS. 13 and 14, the closing member 20 includes: a planar flat surface portion on the outer peripheral portion side; and the third step portion 22 that is formed by recessing the upper surface of the flat surface portion on one main surface side (battery outer side), in the periphery of the hole part 26 (inner peripheral portion side) of the closing member 20. In the third step portion 22, a third step side surface 23 (22) and a third step bottom surface 24 (22) are formed. For information, in the embodiment 6, the third step portion 22 is not essential, and the whole of the closing member 20 may be formed in a planar shape. In the case where the third step portion 22 is provided in the closing member 20, the thickness of the inner peripheral side end portion of the closing member 20 can be thinned. As a result, the amount of the resin of the sealing member 70 can be increased, which is filled in the fourth step portion 52 and the third step portion 22 for sealing the closing member 20, the terminal member 30 and the gasket member 80, in correspondence with the volume of the portion around the inner peripheral portion of the closing member 20, at which the thickness has been thinned by the third step portion 22. Thereby, it is possible to enhance the breaking strength of the base material, and particularly enhance the bonding strength between the sealing member 70 and each of the terminal member 30 and the closing member 20. In addition, the length in the height direction of the circumferential concave portion 55 can be shortened into which the inner peripheral side end portion of the closing member 20 is fitted via the gasket member 80, and accordingly, the height of the battery closing body 1 can be lowered.

In the embodiment 6, the gasket member 80 is arranged so as to be fitted into the circumferential concave portion 55 of the terminal member 30. In other words, as is shown in FIG. 14, the gasket member 80 is arranged along and in close contact with at least the lower surface of the circumferential convex portion 51, the fifth step side surface 63, and the fifth step bottom surface 64.

In addition, the closing member 20 is arranged with respect to the gasket member 80 which has been arranged as in the above. The closing member 20 is arranged so that the inner peripheral end portion of the hole part 26 is fitted from the outer peripheral side of the gasket member 80 arranged in the above into the inner side in the circumferential direction. As shown in FIGS. 13 and 14, the inner peripheral end portion of the third step portion 22 is arranged so as to be fitted into the concave portion 84 of the gasket member 80 from the outer peripheral side of the gasket member 80 so as to be covered thereby. Also in this case, the closing member 20 and the gasket member 80 are arranged in close contact with each other.

The gasket member 80 has an annular shape in a plan view, and includes; an outer peripheral portion in contact with the lower surface of the closing member 20 (lower surface of third step portion 22 in FIG. 13); and an inner peripheral portion that forms a concave portion 84 having an inner wall surface that expands from the outer peripheral portion toward the inner peripheral direction, also rises in the thickness direction along the fifth step side surface 63 of the circumferential concave portion of the terminal member 30, and comes in contact with a lower surface of the inner peripheral end portion of the closing member 20 (in FIG. 13, a lower surface of inner peripheral end portion of the third step bottom surface 24 (22)), the inner peripheral end surface, and the upper surface on the one main surface side (the battery outer side). In addition, the outer peripheral portion of the gasket member 80 is sandwiched from above and below between the fifth step bottom surface 64 (62) of the terminal member 30 and the lower surface of the closing member 20. In addition, the inner peripheral portion of the gasket member 80 in which the inner peripheral end portion of the closing member 20 and the concave portion 84 are fitted to each other is sandwiched from the left and right between the fifth step side surface 63 (62) of the terminal member 30 and the inner peripheral end surface of the hole part 26 of the closing member 20, and also is surrounded by the fifth step bottom surface 64 (62), the fifth step side surface 63 (62), and the lower end surface of the circumferential convex portion 51, and fitted along the circumferential concave portion 55.

In other words, the fifth step side surface 63 (62) in the circumferential concave portion 55 of the terminal member 30 and the inner peripheral end surface of the hole part 26 of the closing member 20 are arranged so as to face each other while sandwiching the gasket member 80. In addition, the fifth step bottom surface 64 (62) of the terminal member 30 of the terminal member 30 and the lower end surface around the hole part 26 of the closing member 20 are arranged so as to face each other while sandwiching the gasket member 80. Due to the outer peripheral portion of the terminal member 30, the inner peripheral portion of the closing member 20 and the gasket member 80 being arranged in this way, in the case where the internal pressure has risen when the battery is used and the terminal member 30 has been pressed toward the outside of the battery, the fifth flange portion 61 serves as a stopper, and thereby can prevent the terminal member 30 from coming off from the battery container. In addition, the fifth flange portion 61 presses the gasket member 80 sandwiched between the terminal member 30 and the closing member 20, thereby, the gasket member 80 is brought into close contact with each of the terminal member 30 and the closing member 20, and the airtightness can be maintained.

As in the above, the terminal member 30 has the circumferential concave portion 55 that is recessed inward in the circumferential direction, in the outer peripheral portion. In addition, the gasket member 80 has the concave portion 84 that is recessed inward in the circumferential direction. In addition, the gasket member 80 covers the periphery of the inner peripheral end portion of the hole part 26 of the closing member 20, and the gasket member 80 is also fitted into the circumferential convex portion 51 and the circumferential concave portion 55. In other words, the gasket member 80 is sandwiched in a state in which the inner peripheral end portion of the closing member 20 and the concave portion 84 of the gasket member 80 are fitted to each other so as to be in close contact with each other, and also the gasket member 80 and the circumferential concave portion 55 of the terminal member are fitted to each other so as to be in close contact with each other. Thereby, even in the case where the terminal member 30 or the gasket member 80 is pressed, when the sealing member 70 has been injection-molded or when the internal pressure of the battery has risen, the deformation of the gasket member 80 is suppressed by the circumferential convex portion 51, and accordingly, it becomes possible to prevent a space from being formed between the gasket member 80 and each of the terminal member 30 and the closing member 20.

Incidentally, due to the terminal member 30, the closing member 20 and the gasket member 80 being arranged in the outer peripheral portion of the terminal member 30, in this way, the outer peripheral portion of the terminal member 30 is arranged in such a way that a part of the circumferential concave portion 55 (fifth step side surface 63 (62)) is inserted into the inside of the hole part 26 of the closing member 20; and the fifth flange portion 61 that is positioned below the circumferential concave portion 55 is arranged in the battery inner side so as to protrude and expands from the lower surface side of the hole part 26 of the closing member 20 in the outer peripheral direction.

Similarly to the embodiments 1 to 5, the sealing member 70 is injection-molded from one main surface side (battery outer side), and thereby, as is shown in FIG. 13, the sealing member is arranged so as to cover the fourth step side surface 53 (52) of the terminal member 30, the fourth step bottom surface 54 (52), the outer peripheral side surface of the circumferential convex portion 51, the outer peripheral portion of the upper end surface of the gasket member 80 (surface exposed from circumferential concave portion 55 to outer peripheral side), and a part of a surface that is exposed from the surface in contact with the gasket member 80 to the outer peripheral side, which is the upper surface of the inner peripheral portion of the hole part 26 of the closing member 20 (third step bottom surface 24 (22) in FIG. 13), from the main surface side. The sealing member 70 is injection-molded in a state in which these members are in close contact with each other without existence of a space that forms an air layer, between each of these members.

In addition, similarly to the embodiments 1 to 5, it is preferable that the bonding surface 27 and the bonding surface 36 each having the hydroxyl group-containing film, the macro concave-convex portion and the fine concave-convex portion are formed at the interface at which the closing member 20 and the terminal member 30 come in close contact with the sealing member 70. Specifically, in the embodiment 6, as is shown in FIG. 13, the bonding surface 36 is formed on the fourth step bottom surface 54 (52) in the circumferential convex portion 51 of the terminal member 30. In addition, the bonding surface 27 is formed on a part of a surface that is exposed to the outer peripheral side from a surface in contact with the gasket member 80, which is an upper surface (third step bottom surface 24 (22) in FIG. 13) of the inner peripheral portion of the hole part 26 of the closing member 20. Similarly to the above, the bonding surface 27 and the bonding surface 36 can be formed by the laser treatment in the film forming step.

The method for producing a battery closing body 1 of an embodiment 6 is performed in the same way as in the embodiments 1 to 5.

### 7. Action Effect

In the case where the electrode terminal (terminal member 30) and the lid plate (closing member 20) are sealed with the use of the sealing member 70 formed from a resin, which has been molded in advance, in the production process (assembly) of the battery, there is a case where an air layer containing air is formed between the sealing member 70 and each of the electrode terminal and the lid plate, depending on the accuracy of the components and the assembly accuracy. In the case where moisture is contained in the air atmosphere in the production environment, the moisture contained in the air atmosphere is sealed in the inside of the air layer of the closing body, in some cases. In this case, the moisture in the air layer reaches the electrolytic solution in the inside of the battery, thereby hydrogen fluoride derived from the electrolytic solution is generated, and the performance of the battery is lowered, in some case. In addition, the sealing member 70 and the filler contained in the sealing member 70 are deteriorated by the generated hydrogen fluoride, in some cases.

According to the present invention, the sealing member 70 is injection-molded in a state in which the terminal member 30, the gasket member 80 and the closing member 20 come in close contact without existence of a space that forms an air layer therebetween, and thereby, it becomes possible to prevent hydrogen fluoride from being generated from the electrolytic solution due to moisture contained in the air layer.

According to the present invention, the sealing member 70 is bonded to each of the terminal member 30, the gasket member 80 and the closing member 20, and thereby, it becomes possible to prevent a leak path from being formed between the sealing member 70 and each of the terminal member 30, the gasket member 80 and the closing member 20. Thereby, it can be prevented that a gas and/or a liquid flow in or flow out through the leak path between the outside and the inside of the battery, and the airtightness and the watertightness can be enhanced.

Even in the case where moisture is mixed into the electrolytic solution in the production process of the battery, and hydrogen fluoride is generated from the electrolytic solution, due to the gasket member 80 being interposed between the closing member 20 and the terminal member 30, it becomes possible to suppress the influence of the hydrogen fluoride which has been generated from the electrolytic solution, on the sealing member 70 and the filler contained in the sealing member 70.

In addition, according to the present invention, a metal holder as in Patent Literature 2 is not required, and the number of components can be reduced. In addition, according to the present invention, it becomes unnecessary to press-fit and weld the molded product after the metal holder and the sealing member have been molded in advance, as in Patent Literature 2, and accordingly, it becomes possible to reduce the number of assembly steps and improve the production efficiency.

In addition, in the present invention, the gasket member 80 which has been molded in advance is inserted between the terminal member 30 and the closing member 20 in a state of being interposed and sandwiched therebetween, and then, the sealing member 70 is injection-molded. Thereby, even in the case where the injection conditions of the gasket member 80 (for example, PFA) and the sealing member 70 (for example, PPS) are different, and the suitable injection conditions of the respective resins cannot be satisfied at the same time (where as for melting temperature of resin, PFA is 400° C. or higher and PPS is 320° C. or higher), both can be combined and integrally molded.

Furthermore, in the present invention, it is preferable to provide the bonding surface 27 and the bonding surface 36 on which the hydroxyl group-containing film, the macro concave-convex portion and the fine concave-convex portion are formed, at the interface of each member of the closing member 20 and the terminal member 30 to which the sealing member 70 comes in close contact (bonded). Thereby, the sealing member 70 is brought into close contact with (bonded to) the closing member 20 and the terminal member 30 via the respective bonding surfaces in a state of having entered the macro concave-convex portion and the fine concave-convex portion, and accordingly the sufficient bonding strength, the airtightness and the watertightness can be expected to be exhibited.

In addition, the present invention has each advantageous action effect as described in the embodiments 1 to 6, in addition to such action effects.

### REFERENCE SIGNS LIST

1 . . . battery closing body
11 metal member
12 . . . resin molded body
13, 13′ . . . trajectory of laser light
14 . . . scanning direction
15 . . . irradiation interval of laser light
16 . . . beam diameter
20 . . . closing member
21 . . . protruding portion
22 . . . third step portion
23 . . . third step side surface
24 . . . third step bottom surface
25 . . . inner peripheral end surface (inner peripheral side surface)
26 . . . hole part
27 . . . bonding surface
30 . . . terminal member
31, 31′, 31″ first flange portion
32, 32′, 32″ first step portion
33, 33′, 33″ first step side surface
34, 34′, 34″ first step bottom surface
35 . . . outer peripheral end surface (outer peripheral side surface)
36 . . . bonding surface
41, 41′ . . . second flange portion
42, 42′. second step portion
43, 43′ second step side surface
44, 44′ second step bottom surface
45 . . . second flange portion side surface
51 . . . circumferential convex portion
52 . . . fourth step portion
53 . . . fourth step side surface
54 . . . fourth step bottom surface
55 . . . circumferential concave portion
61 . . . fifth flange portion
62 . . . fifth step portion
63 . . . fifth step side surface
64 . . . fifth step bottom surface
70 . . . sealing member
80 . . . gasket member
81, 82, 83, 84 . . . concave portion of gasket member
85 . . . intermediate portion of gasket member

1. A battery closing body obtained by integrating a closing member that is formed from metal and closes an opening of a battery container, a terminal member formed from metal, and a gasket member that is interposed between the closing member and the terminal member, by a sealing member, wherein
the gasket member contains a first thermoplastic resin that has resistance to hydrogen fluoride;
the sealing member contains a second thermoplastic resin;
the closing member has a generally planar main body part and a hole part that is provided so as to penetrate the main body part in a thickness direction;
the gasket member that has been molded in advance is sandwiched between an outer peripheral portion of the terminal member and the inner peripheral portion of the hole part of the closing member; and
the sealing member is injection-molded in a state in which the terminal member, the gasket member and the closing member are in close contact to the sealing member without existence of a space that forms an air layer, between each of the members and the sealing member.

2. The battery closing body according to claim 1, wherein
the terminal member is arranged in a state in which at least a part of the terminal member is exposed on one main surface side of the closing member, and
the sealing member covers the outer peripheral portion of the terminal member, the gasket member, and the inner peripheral portion of the closing member, on the one main surface side.

3. The battery closing body according to claim 1, wherein a lower end surface of the outer peripheral portion of the terminal member and an upper end surface of the inner peripheral portion of the hole part of the closing member are arranged so as to face each other while sandwiching the gasket member therebetween.

4. The battery closing body according to claim 1, wherein an outer peripheral end surface of the outer peripheral portion of the terminal member and an inner peripheral end surface of the hole part of the closing member are arranged so as to face each other while sandwiching the gasket member therebetween.

5. The battery closing body according to claim 3, wherein
the terminal member has a flange portion in the outer peripheral portion, the flange portion having a surface opposite to a surface facing the closing member that is lowered by one step and protrudes and expands in an outer peripheral direction, and
the sealing member is molded so as to cover the whole surface of the flange portion, which is exposed on the one main surface side, except for a portion of the flange portion in contact with the gasket member.

6. The battery closing body according to claim 2, wherein
the terminal member has one or more flange portions in the outer peripheral portion, each of the flange portions having a surface on the one main surface side that is lowered by at least one step, protrudes and expands in an outer peripheral direction, and
at least one of the flange portions is arranged so that a step bottom surface of the flange portion and a lower end surface of an inner peripheral portion of the hole part of the closing member face each other while sandwiching the gasket member therebetween.

7. The battery closing body according to claim 2, wherein the closing member has a stepped portion that is lowered by one step, in the inner peripheral portion on the one main surface side.

8. The battery closing body according to claim 1, wherein
the closing member has a protruding portion that protrudes in a thickness direction in a vicinity of the inner peripheral portion,
the gasket member has a concave portion that is recessed in the thickness direction, and
the gasket member is sandwiched in a state in which the protruding portion of the closing member and the concave portion of the gasket member are fitted to each other so as to be in close contact with each other.

9. The battery closing body according to claim 1, wherein
the terminal member has a circumferential concave portion in the outer peripheral portion, which is recessed inward in a circumferential direction;
the gasket member has a concave portion that is recessed inward in a circumferential direction, and
the gasket member is sandwiched in a state in which an inner peripheral end portion of the closing member and the concave portion of the gasket member are fitted to each other so as to be in close contact with each other, and also, the gasket member and the concave portion of the terminal member are fitted to each other so as to be in close contact with each other.

10. The battery closing body according to claim 1, wherein the closing member and the terminal member each have a bonding surface on which a hydroxyl group-containing film containing a hydroxyl group is formed, on an interface with the sealing member.

11. The battery closing body according to claim 10, wherein
the hydroxyl group-containing film has a macro concave-convex portion including a plurality of concave-convex portions each having an opening diameter (D) of 20 μm to 200 μm, depths (L) of 20 μm to 200 μm, and aspect ratios (L/D) of the opening diameters (D) to the depths (L) of 0.5 to 5, and also has fine concave-convex portions having a plurality of openings from 10 nm to 50 nm and a thickness of 10 nm to 1000 nm on the surface of the macro concave-convex portion, and
the closing member and the terminal member are each bonded to the sealing member via the bonding surface in a state in which the sealing member enters the macro concave-convex portions and the fine concave-convex portions.

12. A method for producing a battery closing body that is obtained by integrating a closing member that is formed from metal and closes an opening of a battery container, a terminal member formed from metal, and a gasket member that is interposed between the closing member and the terminal member, by a sealing member, wherein
the gasket member contains a first thermoplastic resin that has resistance to hydrogen fluoride;
the sealing member contains a second thermoplastic resin;
the closing member has a generally planar main body part and a hole part that is provided so as to penetrate the main body part in a thickness direction, wherein
the method comprises: a member preparation step of sandwiching the gasket member molded in advance between an outer peripheral portion of the terminal member and an inner peripheral portion of the hole part of the closing member; and
an injection molding step of injection-molding the sealing member so that the sealing member reaches a state of being in close contact with the terminal member, the gasket member, and the closing member without existence of a space that forms an air layer, between each of the members and the sealing member.

13. The method for producing the battery closing body according to claim 12, wherein
in the member preparation step, the terminal member is arranged in a state in which at least a part of the terminal member is exposed on one main surface side of the closing member; and
in the injection molding step, the injection molding is performed so that the sealing member covers the outer peripheral portion of the terminal member, the gasket member, and the inner peripheral portion of the closing member, on the one main surface side.

14. The method for producing the battery closing body according to claim 12, further comprising a film forming step of forming a bonding surface on which a hydroxyl group-containing film containing a hydroxyl group is formed, on each of surfaces of the closing member and the terminal member, by laser treatment of irradiating the surfaces of the closing member and the terminal member with laser light, wherein
the member preparation step and the injection molding step are performed with the use of the closing member and the terminal member obtained in the film forming step.

15. The method for producing the battery closing body according to claim 14, wherein
in the film forming step, the bonding surface is formed on each of the outer peripheral portion of the terminal member and the inner peripheral portion of the hole part of the closing member, on the one main surface side on which the injection molding is performed;
in the member preparation step, the terminal member and the closing member are arranged so that the bonding surface formed on the terminal member and the bonding surface formed on the closing member are exposed toward the one main surface side; and
in the injection molding step, the injection molding is performed so that the sealing member covers the bonding surfaces of the terminal member and the closing member, on the one main surface side.
